(19) United States
(12) Patent Application Publication
(10) Pub. No.: US 2026/0017155 A1
(43) Pub. Date: Jan. 15, 2026

(54) STORAGE SYSTEM AND STORAGE CONTROL METHOD

(71) Applicant: Hitachi Vantara, Ltd., Yokohama-shi (JP)

(72) Inventors: Shintaro ITO, Tokyo (JP); Sachie TAJIMA, Tokyo (JP); Takahiro YAMAMOTO, Tokyo (JP); Yoshinori OHIRA, Tokyo (JP)

(73) Assignee: Hitachi Vantara, Ltd., Yokohama-shi (JP)

(21) Appl. No.: 19/075,965

(22) Filed: Mar. 11, 2025

(30) Foreign Application Priority Data
Jul. 11, 2024 (JP) 2024-111913

(51) Int. Cl. G06F 11/16; G06F 11/14

(52) U.S. Cl. CPC G06F 11/1612; G06F 11/1471; G06F 11/1662

(57) ABSTRACT

A storage controller (for example, a storage control unit 123) can execute log creation processing of, when a write request is processed and control information or cache data is updated, adding a header to the updated data to create an update log and storing the update log in a log buffer. In the log creation processing when first-type control information (normal control information) is updated, the storage controller adds a log header to each piece of updated first-type control information to create an update log (normal log 132), and in the log creation processing when second-type control information (cache directory) is updated, the storage controller creates one consolidated log (consolidated log 137) as an update log related to a plurality of pieces of second-type control information.

### BACKGROUND OF THE INVENTION

### 1. Field of the Invention

The present invention relates to a storage system and a storage control method.

### 2. Description of Related Art

In related art, a redundant configuration has been adopted in a storage system in order to improve availability and reliability.

For example, PTL 1 discloses a storage system including a plurality of storage nodes each including one or a plurality of storage apparatuses that provide a storage region, and one or a plurality of storage control units that read and write requested data from and to a corresponding storage apparatus in response to a request from a higher-level apparatus. In the storage system disclosed in PTL 1, each storage control unit retains predetermined configuration information necessary for reading and writing the requested data from and to the corresponding storage apparatus in response to the request from the higher-level apparatus, and a plurality of pieces of control software are managed as a redundancy group. In the storage system disclosed in PTL 1, the configuration information retained by each piece of control software belonging to the same redundancy group is synchronously updated in the redundancy group, and a plurality of pieces of control software constituting the redundancy group are disposed in different storage nodes to distribute loads on the respective storage nodes, thereby implementing a redundancy configuration.

### CITATION LIST

### Patent Literature

PTL 1: JP2023-152247A

### SUMMARY OF THE INVENTION

According to the storage system in PTL 1 described above, using a technique for configuring a storage system by software (software defined storage (SDS)), it can be expected to provide a high reliability storage service that can continue reading and writing even when a node failure occurs and can efficiently non-volatilize control information and cache data to prevent loss even during a power outage.

However, in the storage system in PTL 1, when an update size of the control information is small and the number of updates is large (specifically, for example, cache directory information retained in a cache directory), an amount of logs created along with an update of the control information is large and thus a processing load of a processor (CPU) increases. When the update of the control information is made redundant or non-volatile (stored on a disk), a total amount of management information (header) added to update data increases, and thus a transfer volume to a network and a disk also increases. That is, in the storage system in PTL 1, in processing along with the update of the control information, the control information having a small update size and a large number of updates (for example, cache directory information) increases loads on the processor, the network, and the disk, and there is a possibility that performance may degrade.

The invention has been made in view of the above points and proposes a storage system and a storage control method that can obtain both high performance and high reliability even when control information is updated.

In order to solve the problems, the invention provides a storage system including one or more storage nodes each including a volatile memory, a non-volatile storage device, and a storage controller that processes data read from or written to at least the memory or the storage device, in which the memory stores cache data and control information for accessing data on the storage device, as the data is written in response to a write request, the control information corresponding to the data is updated, and the control information includes first-type control information and second-type control information having an update size smaller than that of the first-type control information, the storage controller is configured to execute log creation processing of, when the write request is processed and the control information or the cache data is updated, adding a header to updated data to create an update log and storing the created update log in a log buffer in the memory, update log non-volatilization processing of storing, in the storage device, the update log stored in the log buffer by the log creation processing, and responding to a requestor of the write request, and destaging processing of destaging, to the storage device, the update log stored in the log buffer in the memory, in the log creation processing when the first-type control information is updated, the storage controller adds a log header to each piece of the updated first-type control information to create an update log, and stores the update log in the log buffer, and in the log creation processing when the second-type control information is updated, the storage controller creates one consolidated log as an update log related to a plurality of pieces of the second-type control information, and stores the consolidated log in the log buffer.

In order to solve the problems, the invention also provides a storage control method performed by a storage system including one or more storage nodes, in which the one or more storage nodes each include a volatile memory, a non-volatile storage device, and a storage controller that processes data read from or written to at least the memory or the storage device, the memory stores cache data and control information for accessing data on the storage device, as the data is written in response to a write request, the control information corresponding to the data is updated, and the control information includes first-type control information and second-type control information having an update size smaller than that of the first-type control information, the method includes: a log creation step of, when the write request is processed and the control information or the cache data is updated, causing the storage controller to add a header to updated data to create an update log and store the created update log in a log buffer in the memory; an update log non-volatilization step of causing the storage controller to store, in the storage device, the update log stored in the log buffer in the log creation step, and to respond to a requestor of the write request; and a destaging step of causing the storage controller to destage, to the storage device, the update log stored in the log buffer in the memory, in the log creation step when the first-type control information is updated, the storage controller adds a log header to each piece of the updated first-type control information to create an update log, and stores the update log in the log buffer, and in the log creation step when the second-type control information is updated, the storage controller creates one consolidated log as an update log related to a plurality of pieces of the second-type control information, and stores the consolidated log in the log buffer.

According to the invention, both high performance and high reliability can be obtained.

### BRIEF DESCRIPTION OF THE DRAWINGS

FIG. 1 shows a configuration example of a storage system 100 according to a first embodiment of the invention.

FIG. 2 shows a physical configuration example of a storage node 103.

FIG. 3 shows a logical configuration example of the storage node 103.

FIG. 4 shows an overview of a storage control method in the storage system 100.

FIG. 5 shows a detailed configuration example of an update log created in the storage system 100.

FIG. 6 shows a configuration example of a memory 112.

FIG. 7 shows a configuration example of a storage device 113.

FIG. 8 shows an example of a software module structure in a storage control unit 123.

FIG. 9 shows a configuration example of a cache directory 142.

FIG. 10 shows a configuration example of a log header 133.

FIG. 11 shows a configuration example of a consolidated log header 138.

FIG. 12 shows a configuration example of a log header 136 in a small-size log 135.

FIG. 13 is a flowchart of a processing procedure example of read processing.

FIG. 14 is a flowchart showing a processing procedure example of write processing.

FIG. 15 is a flowchart showing a processing procedure example of asynchronous destaging processing.

FIG. 16 is a flowchart showing a processing procedure example of control information update processing.

FIG. 17 is a flowchart showing a processing procedure example of cache data update processing.

FIG. 18 is a flowchart showing a processing procedure example of normal log creation processing.

FIG. 19 is a flowchart showing a processing procedure example of control information update determination processing.

FIG. 20 is a flowchart showing a processing procedure example of log redundancy processing.

FIG. 21 is a flowchart showing a processing procedure example of log evacuation processing.

FIG. 22 is a flowchart showing a processing procedure example of log recovery processing.

FIG. 23 shows a modification in which a size of information indicating a log reflection position is reduced.

FIG. 24 shows a data processing image of a compression function.

### DESCRIPTION OF EMBODIMENTS

Hereinafter, embodiments according to the invention will be described with reference to the drawings.

The following description and drawings are examples for describing the invention, and are omitted and simplified as appropriate for clarity of description. Not all combinations of features described in the embodiments are necessarily required for solution of the invention. The invention is not limited to the embodiments, and any application example that matches the idea of the invention is within the technical scope of the invention. Those skilled in the art can make various additions and modifications to the invention within the scope of the invention. The invention can be implemented in various other forms. Unless otherwise specified, each component may be single or plural.

In the following description, an “interface apparatus” may be one or more communication interface devices. The one or more communication interface devices may be one or more communication interface devices of the same type (for example, one or more network interface cards (NICs)) or two or more communication interface devices of different types (for example, an NIC and a host bus adapter (HBA)).

In the following description, a “memory” is one or more memory devices, which are examples of one or more storage devices, and may be typically a main storage device. At least one memory device in the memory may be a volatile memory device or a non-volatile memory device.

In the following description, a “persistent storage apparatus” may be one or more persistent storage devices, which are examples of one or more storage devices. The persistent storage device is typically a non-volatile storage device (for example, an auxiliary storage device), and specifically may be, for example, a hard disk drive (HDD), a solid state drive (SSD), or a non-volatile memory express (NVMe) drive.

In the following description, a “processor” may be one or more processor devices. At least one processor device may typically be a micro-processor device such as a central processing unit (CPU), and may also be a processor device of another type such as a graphics processing unit (GPU). At least one processor device may be single-core or multi-core. At least one processor device may be a processor core. At least one processor device may be a broad-sense processor device such as a hardware circuit that performs a part or all of processing (for example, a field-programmable gate array (FPGA), a complex programmable logic device (CPLD), or an application specific integrated circuit (ASIC)).

In the following description, various types of information may be described using terms such as “table”, “chart”, “list”, and “queue”, and the various types of information may also be represented by data structures (data configurations) other than these. In order to indicate that the information does not depend on the data structure, “XX table”, “XX list”, and the like may be referred to as “XX information”. When describing information contents, terms such as “identification information”, “identifier”, “name”, “ID”, and “number” are used, and the terms can be replaced with one another. In the following description, a configuration of each table is an example, and one table may be divided into two or more tables, or all or a part of two or more tables may be one table.

In the following description, processing may be described by executing a program, the program may be executed by at least one processor (for example, a CPU) to execute predetermined processing using a storage resource (for example, a memory) and/or an interface device (for example, a communication port) as appropriate, and thus an entity of the processing may be the processor. Similarly, the entity of the processing performed by executing the program may be a controller, an apparatus, a system, a computer, a node, a storage system, a storage apparatus, a server, a management computer, a client, or a host including the processor. The entity (for example, the processor) of the processing performed by executing the program may include a hardware circuit that performs a part or all of the processing. For example, the entity of the processing performed by executing the program may include a hardware circuit that executes encryption and decryption or compression and decompression. The processor operates as a functional unit that implements a predetermined function by operating according to the program. An apparatus and a system including the processor are an apparatus and a system including such a functional unit.

The program may be installed on an apparatus such as a computer from a program source. The program source may be, for example, a program distribution server or a computer-readable non-transitory storage medium. When the program source is the program distribution server, the program distribution server may include a processor (for example, a CPU) and a non-transitory storage resource, and the storage resource may further store a distribution program and a program to be distributed. When the processor of the program distribution server executes the distribution program, the processor of the program distribution server may distribute the program to be distributed to another computer. In the following description, two or more programs may be implemented as one program, or one program may be implemented as two or more programs.

In the following description, when elements of the same type are described without distinction, a common portion of reference signs including subscripts or branch numbers (a portion excluding the subscripts or the branch numbers) may be used, and when the elements of the same type are described with distinction, the reference signs including the subscripts or the branch numbers may be used. When describing storage nodes without particular distinction, the storage nodes may each be referred to as “storage node 103”, and on the other hand, when describing individual storage nodes 103 with distinction, the storage nodes may be labeled with subscripts, such as “storage node 103A” and “storage node 103B”. Each element may be described using an identifier (ID) or the like assigned to the target element. Specifically, for example, the storage node 103A may be referred to as “storage node #1” and the storage node 103B may be referred to as “storage node #2”.

### (1) First Embodiment

### (1-1) System Configuration

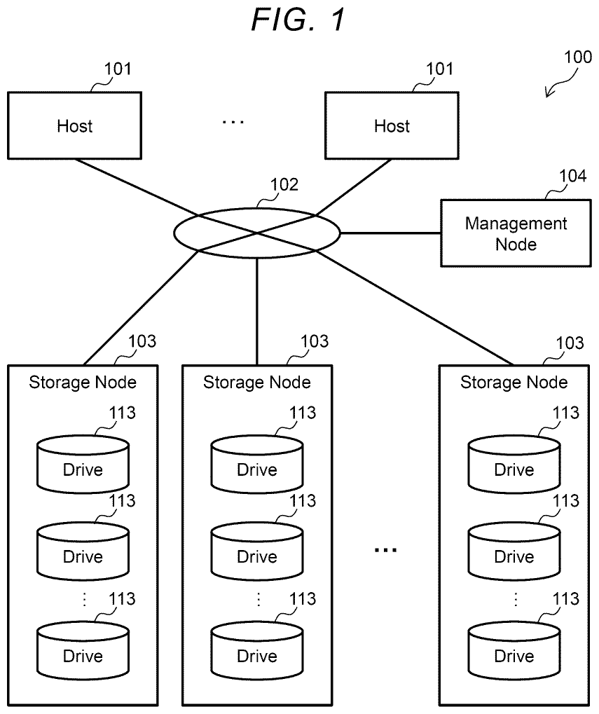

FIG. 1 shows a configuration example of a storage system 100 according to a first embodiment of the invention. As shown in FIG. 1, the storage system 100 includes, for example, a plurality of host apparatuses 101 (Hosts), a plurality of storage nodes 103, and a management node 104. The host apparatuses 101, the storage nodes 103, and the management node 104 are connected to one another via a network 102 including a fibre channel, Ethernet (registered trademark), a local area network (LAN), or the like.

Each host apparatus 101 is, for example, a general-purpose computer apparatus, which transmits an input and output request such as a read request or a write request (hereinafter, also collectively referred to as an input/output (I/O) request as appropriate) to each storage node 103 in response to a user operation or a request from an implemented application program. The host apparatus 101 may be a virtual computer apparatus such as a virtual machine.

The storage node 103 is a computer apparatus that provides, to the host apparatus 101, a storage region for reading and writing data. The storage node 103 is, for example, a general-purpose server apparatus.

The management node 104 is a computer apparatus used by a system administrator to manage the entire storage system 100. The management node 104 manages the plurality of storage nodes 103 as a group called a cluster. FIG. 1 shows an example in which one cluster is provided, and the storage system 100 according to the embodiment may be provided with a plurality of clusters in the system.

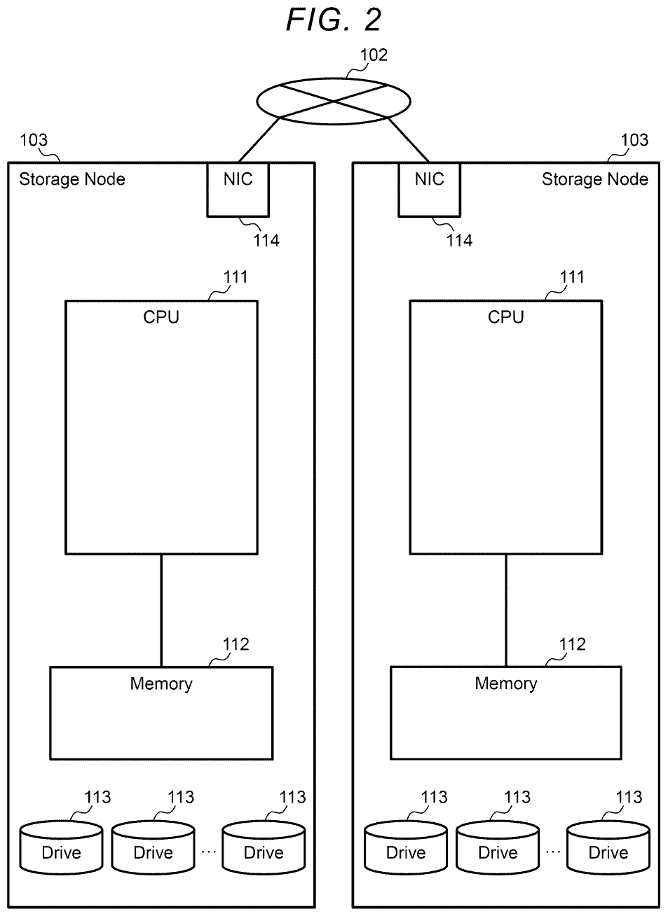

FIG. 2 shows a physical configuration example of the storage node 103. As shown in FIG. 2, the storage node 103 includes, for example, a central processing unit (CPU) 111, a memory 112, a plurality of storage devices 113 (Drive), and a communication apparatus 114 (NIC: network interface card).

The CPU 111 is a processor that handles overall operation control in the storage node 103 thereof. The memory 112 is a volatile storage apparatus, and specifically includes a semiconductor memory such as a static random access memory (static RAM (SRAM)) or a dynamic RAM (DRAM). The memory 112 is used to temporarily retain various programs, data necessary for executing these programs, and the like. The CPU 111 executes a program stored in the volatile memory 112 and thus executes various types of processing of the storage node 103 as a whole to be described later.

The storage device 113 is a non-volatile storage apparatus, and specifically, for example, includes one or a plurality of types of large-capacity non-volatile storage apparatuses such as a solid state drive (SSD), a serial attached small computer system interface (serial attached SCSI (SAS)) standard hard disk drive (HDD), or a serial advanced technology attachment (serial ATA (SATA)) standard HDD. The storage device 113 provides a physical storage region for reading or writing data in response to an I/O request from the host apparatus 101.

The communication apparatus 114 is an interface for the host storage node 103 thereof to communicate with another node (the host apparatus 101, the management node 104, or another storage node 103) via the network 102, and performs protocol control during the communication. Specifically, the communication apparatus 114 includes, for example, an NIC or an FC card.

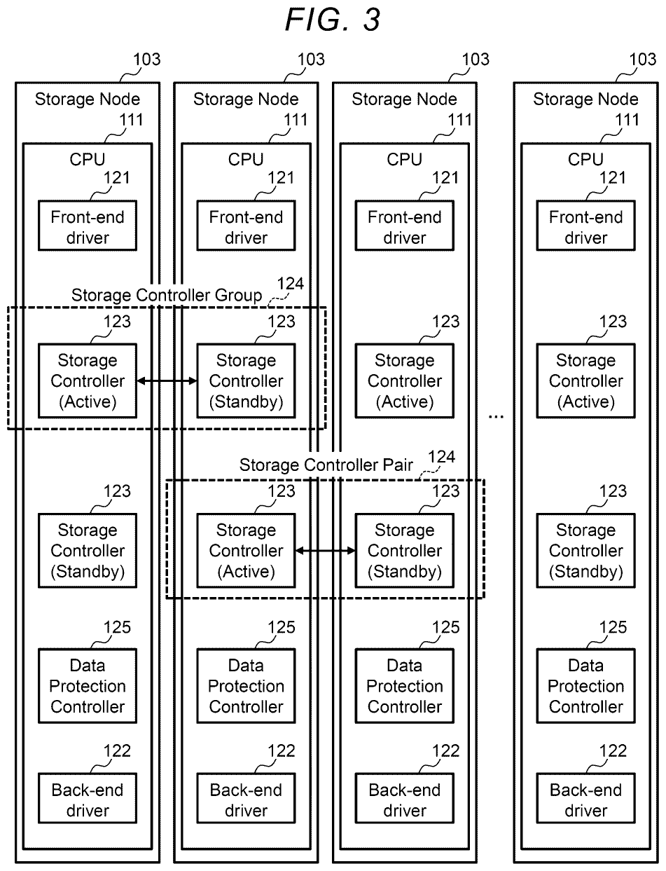

FIG. 3 shows a logical configuration example of the storage node 103. As shown in FIG. 3, the storage node 103 includes a front-end driver 121, a back-end driver 122, one or a plurality of storage control units 123 (Storage Controller), and a data protection control unit 125 (Data Protection Controller) as software that provides the CPU 111 with each predetermined function.

The front-end driver 121 is software that has a function of controlling the communication apparatus 114 and providing an abstract interface to the CPU 111 (storage control unit 123) during communication with another node (the host apparatus 101, the management node 104, or another storage node 103).

The back-end driver 122 is software having a function of controlling each storage device 113 in the host storage node 103 thereof and providing an abstract interface to the CPU 111 (storage control unit 123) during communication with each storage device 113.

The storage control unit 123 is software (storage controller) that functions as a controller of software defined storage (SDS). The storage control unit 123 receives the I/O request from the host apparatus 101 and issues an I/O command corresponding to the I/O request to the data protection control unit 125. The storage control unit 123 also has a logical volume configuration function for implementing a logical volume. The logical volume configuration function is a function of associating a logical chunk implemented by the data protection control unit 125 with the logical volume provided to the host apparatus 101, and specifically may use, for example, a straight mapping method (a method in which the logical chunk and the logical volume are associated one-to-one, and an address of the logical chunk and an address of the logical volume are the same), or a virtual volume method such as thin provisioning (a method in which the logical volume and the logical chunk are divided into small-size regions (pages), and the addresses of the logical volume and the logical chunk are associated with each other in units of pages).

In the storage system 100 according to the embodiment, each storage control unit 123 implemented in the storage node 103 is managed as a pair constituting a redundant configuration in combination with the storage control unit 123 provided in another storage node 103. Such a redundant configuration pair formed by the storage control units 123 of different storage nodes 103 is referred to as a storage control unit group 124 (Storage Controller Group).

In FIG. 3, a case where one storage control unit group 124 is implemented by two storage control units 123 is shown as an example of the redundant configuration in the storage system 100, and such a configuration example is the same in other descriptions below. The redundant configuration in the storage system 100 is not limited to this example, and one redundant configuration (storage control unit group 124) may be implemented by three or more storage control units 123.

In the storage control unit group 124, one storage control unit 123 is set in a state in which the I/O request from the host apparatus 101 can be received (an active state, hereinafter referred to as an active mode). In the storage control unit group 124, the other storage control unit 123 is set in a state in which the I/O request from the host apparatus 101 is not received (a standby state, hereinafter referred to as a standby mode).

In the storage system 100, for example, when a failure occurs in the storage control unit 123 set to the active mode (active storage control unit) or the storage node 103 where the active storage control unit is provided, the active-side storage control unit 123 may not be capable of continuing a normal operation (it is difficult to continue storage control by the active storage control unit), and thus the state of the storage control unit 123 set to the standby mode (standby storage control unit) so far in the corresponding storage control unit group 124 is switched to the active mode. Due to such switching, when the active storage control unit cannot operate, I/O processing executed by the active storage control unit can be taken over by the standby storage control unit in the same storage control unit group 124, and thus availability is improved.

The data protection control unit 125 is software having a function of allocating, to each storage control unit group 124, a physical storage region provided by the storage device 113 in the storage node 103 thereof or in another storage node 103, and reading or writing specified data from or to the corresponding storage device 113 according to the I/O command described above issued from the storage control unit 123.

More specifically, when the physical storage region provided by the storage device 113 in the other storage node 103 is allocated to the storage control unit group 124, the data protection control unit 125 cooperates with the data protection control unit 125 implemented in the other storage node 103 to exchange data with the data protection control unit 125 via the network 102, thereby reading or writing the data from or to the allocated storage region according to the I/O command issued from the active storage control unit in the storage control unit group 124. Since the data protection control unit 125 is software executed by the processor (CPU 111) in the storage node 103, the data protection control unit 125 is a “storage controller” similarly to the storage control unit 123.

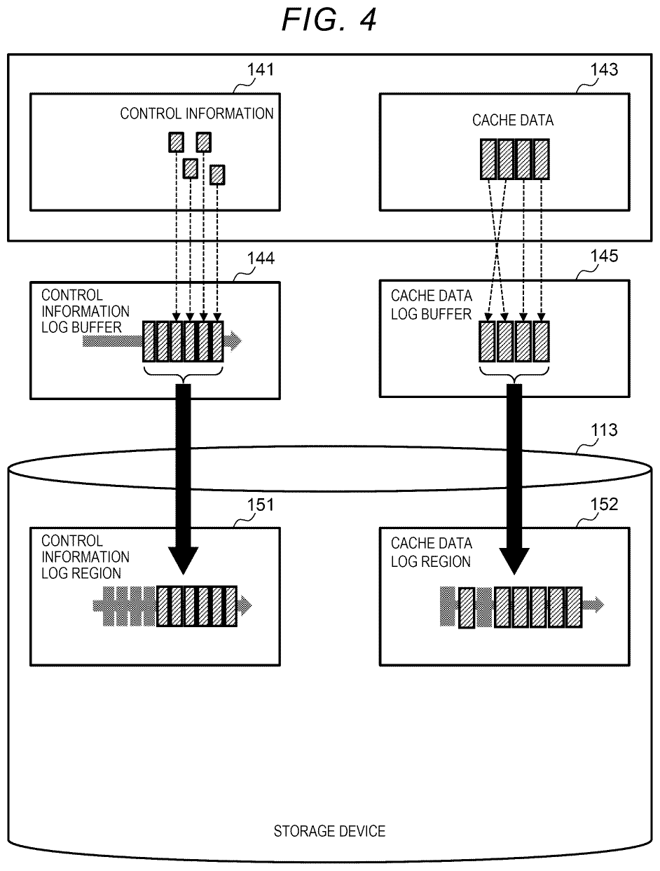

FIG. 4 shows an overview of a storage control method in the storage system 100. The storage control unit 123 updates storage control information or cache data for processing according to the I/O request received from the host apparatus 101 (I/O processing) or various other types of processing. The term “update storage control information or cache data” may include both the update of the storage control information and the update of the cache data, and the same applies to the following description.

The storage control information is control information (storage control information) for implementing various storage functions by the storage system 100 (storage control unit 123), and the storage control information updated by the storage control unit 123 is stored in a control information region 141 on the memory 112. As for the storage control information, when data is written to the storage system 100 (the memory 112 or the storage device 113) in response to the write request (including both a new write and an overwrite), the storage control information corresponding to the data is updated. The cache data is data that temporarily stores at least a part of predetermined information related to implementation of various storage functions by the storage system 100 (storage control unit 123), and, for example, user data is treated as the cache data. The cache data updated by the storage control unit 123 is stored in a cache data region 143 on the memory 112.

When updating the storage control information or the cache data, the storage control unit 123 according to the embodiment updates the control information or the cache data on the memory 112 and stores a log of the update in the non-volatile storage device 113, thereby enabling non-volatilization of update data.

As shown in FIG. 4, in order to non-volatilize the log, the storage control unit 123 creates a log related to the update of the control information (update log) in a control information log buffer 144 on the memory 112 when updating the control information, and creates a log related to the update of the cache data (update log) in a cache data log buffer 145 on the memory 112 when updating the cache data. Further, the storage control unit 123 writes the update logs on the log buffers 144 and 145 to log regions (a control information log region 151 and a cache data log region 152) on the storage device 113 at predetermined timings in an append writing manner, thereby implementing non-volatilization of the update data. The update log on the memory 112 may be written to the storage device 113 immediately when the control information or the cache data is updated, or may be written out asynchronously with the update.

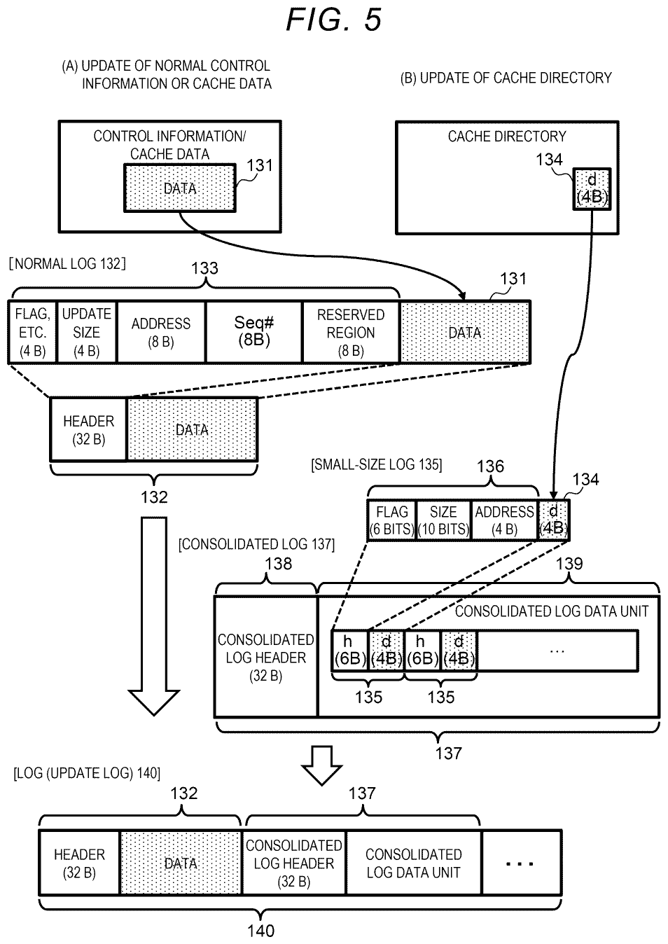

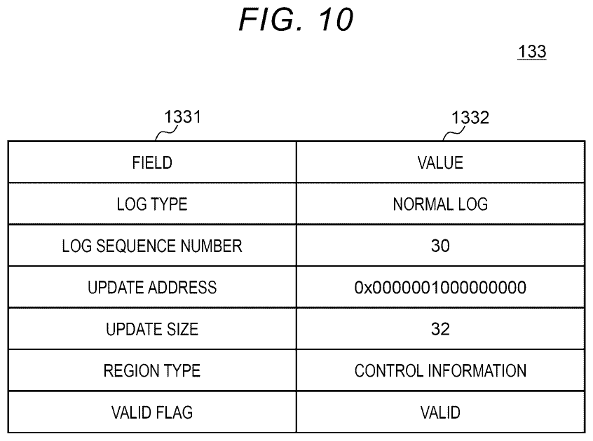

The update log is information indicating how the control information or the cache data on the memory 112 is updated, and includes the update data and a header (log header). The log header includes information indicating an update location (update address), an update size, an update order relationship, and the like (for example, see FIG. 10). A detailed configuration of the update log will be described with reference to FIG. 5.

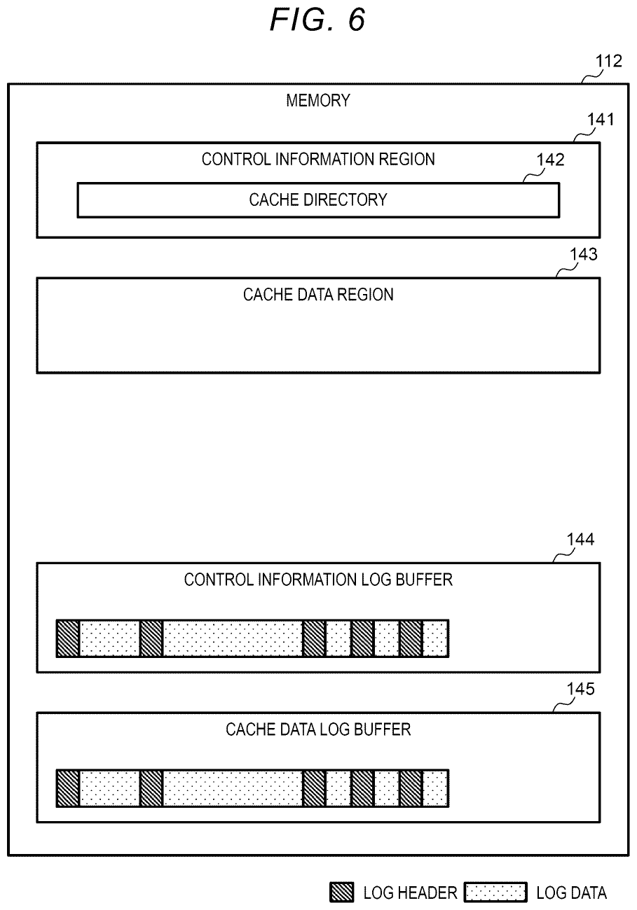

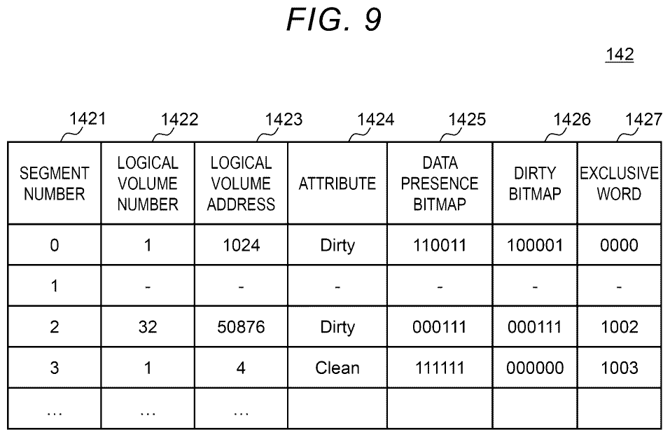

FIG. 5 shows a detailed configuration example of the update log created in the storage system 100. The control information managed by the memory 112 in the storage node 103 according to the embodiment includes a cache directory (cache directory information) in addition to the control information described in FIG. 4 (hereinafter, may be referred to as normal control information). The cache directory (cache directory information) is management information of a cache segment that is a region obtained by subdividing a cache area, and holds an entry corresponding to each cache segment. FIG. 6 to be described later shows a configuration example of the memory 112, and a cache directory 142 is also stored in the control information region 141 where the control information is stored in addition to the normal control information. In FIG. 9 to be described later, a configuration example of the cache directory 142 will be described.

One feature of the storage system 100 according to the embodiment is that a format of a created log (update log) differs between when the normal control information or the cache data is updated as described in FIG. 4 and when the cache directory is updated as will be described later. In FIG. 5, (A) shows a method for creating the update log when the normal control information or the cache data is updated, and (B) shows a method for creating the update log when the cache directory is updated.

First, (A) in FIG. 5 will be described. When the normal control information or the cache data is updated, the storage control unit 123 generates and adds a normal log header 133 (a log header generated and added at the time of creating a normal update log) for each piece of update data (data 131) to create a normal log 132, and inserts the normal log 132 in a log buffer (in the control information log buffer 144 shown in FIG. 6 in the case of the normal log 132 along with the update of the normal control information, and in the cache data log buffer 145 shown in FIG. 6 in the case of the normal log 132 along with the update of the cache data). For example, a data size of the normal log header 133 is 32 bytes (32 B) as shown in FIG. 5.

Next, FIG. 5B will be described. When the cache directory is updated, the storage control unit 123 generates a small-size log 135 by generating and adding a small-size log header 136 for each piece of update data (data 134). Further, the storage control unit 123 combines a plurality of small-size logs 135 generated as described above into one data unit (consolidated log data unit 139), generates and adds a log header (consolidated log header 138) for the consolidated log data unit 139 to create a consolidated log 137, and inserts the consolidated log 137 into the log buffer (the control information log buffer 144 shown in FIG. 6). Hereinafter, the processing of combining the plurality of small-size logs 135 (and further adding the consolidated log header 138) to create the consolidated log 137 is also referred to as “consolidation”.

As described above, the normal log 132 is created as the update log along with the update of the normal control information or the cache data, and the consolidated log 137 is created as the update log along with the update of the cache directory. Among these, both the normal log 132 along with the update of the normal control information and the consolidated log 137 along with the update of the cache directory are inserted into the control information log buffer 144, and thus as shown in a lower part in FIG. 5, a log (update log) 140 is implemented in the control information log buffer 144 by concatenating any number of normal logs 132 and consolidated logs 137.

Here, a data size of each log is checked with reference to FIG. 5.

In the normal log 132 created along with the update of the normal control information or the cache data, the data size of the log header 133 is 32 bytes (32 B), which is allocated as follows: 4 bytes (hereinafter, the byte is also referred to as “B”) for “FLAG, ETC.” where information such as a log type and a valid flag are stored, 4 B for “UPDATE SIZE” where information on a data size of the data 131 is stored, 8 B for “UPDATE ADDRESS” where address information on the data 131 is stored, 8 B for “Seq #” where information on a log sequence number of the normal log 132 is stored, and 8 B for “RESERVED REGION” that is a reserved region used for storing other information or the like. The data size of the data 131 is, for example, 32 B as shown in FIG. 10 to be described later, but is not limited thereto, and may be a data size of less than 32 B or a data size of 32 B or more. However, in general, the data size of the data 131 that is the update data of the normal control information or the cache data is larger than a data size (“4 B” in the example in FIG. 5) of the data 134 that is the update data of the cache directory.

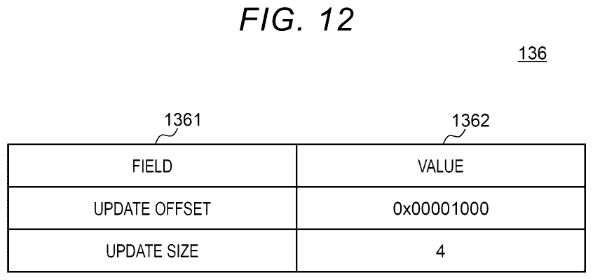

On the other hand, in the update of the cache directory, since data is updated in units of cache segments obtained by subdividing the cache area, a data size of one piece of update data (data 134) is significantly smaller than the data size of the update data (data 131) in the update of the normal control information or the cache data (specifically, for example, 4 B). A data size of the small-size log 135 corresponding to each individual piece of data 134 is made smaller than that of the normal log 132 by omitting an unnecessary log field and minimizing a storage region for a necessary log field. Specifically, in the small-size log 135 shown in FIG. 5, a header portion for one piece of data 134 (a data size of 4 bytes) has a data size of 6 bytes in total allocated as follows: 4 bits for “FLAG”, 10 bits for “SIZE”, and 4 bytes for “ADDRESS” (details of each field will be described later with reference to FIG. 12). Therefore, the data size of one small-size log 135 is only 10 B at most even when 6 B of the header portion and 4 B of the data 134 are summed up. Then, the consolidated log 137 is created by combining a plurality of such small-size logs 135 into the consolidated log data unit 139 and adding the consolidated log header 138 of 32 B, and thus an effect of reducing the entire data size by consolidation increases as the number of small-size logs 135 (which may be interpreted as cache directory update data (data 134)) in one consolidated log 137 increases.

Specifically, the data size of the update log created along with an update of one piece of data 131 (normal log 132) in the normal control information or the cache data is 32 B+32 B=64 bytes. On the other hand, since a data size of the update log created along with the data update in the cache directory (the consolidated log 137) is 32+10n bytes when the number of small-size logs 135 (which may be interpreted as the data 134 of the update data) in one consolidated log 137 is n and a data size per one piece of update data is 32/n+10 bytes, it is evident that the size is significantly smaller than 64 bytes, which is the data size of the normal log 132.

FIG. 6 shows a configuration example of the memory 112. As shown in FIG. 6, the memory 112 includes the control information region 141, the cache data region 143, the control information log buffer 144, and the cache data log buffer 145.

The control information region 141 is a region where control information for implementing various storage functions (storage control information) is stored. Specifically, in addition to the above-described normal control information, the cache directory 142 (information constituting the cache directory 142) that is the management information of the cache segment is stored.

The control information log buffer 144 is a log buffer that temporarily retains the update log of the control information (storage control information), and more specifically, the update log created along with the update of the normal control information (normal log 132) and the update log updated along with the update of the cache directory 142 (consolidated log 137) are placed therein. In the control information log buffer 144, the normal log 132 and the consolidated log 137 may be stored in a concatenated configuration as the update log 140 described in FIG. 5, or may be stored individually.

Meanwhile, the cache data region 143 is a region where the cache data is stored. The cache data log buffer 145 is a log buffer that temporarily retains the update log of the cache data, and more specifically, the update log created along with the update of the cache data (normal log 132) is placed therein.

The update log temporarily stored in the log buffer (the control information log buffer 144 and the cache data log buffer 145) is written to the log region on the non-volatile storage device 113 at a predetermined timing by the storage control unit 123, and is deleted from the log buffer after the writing is completed, details of which will be described later. When the update log is written in the log region on the non-volatile storage device 113, non-volatilization of the update data is implemented.

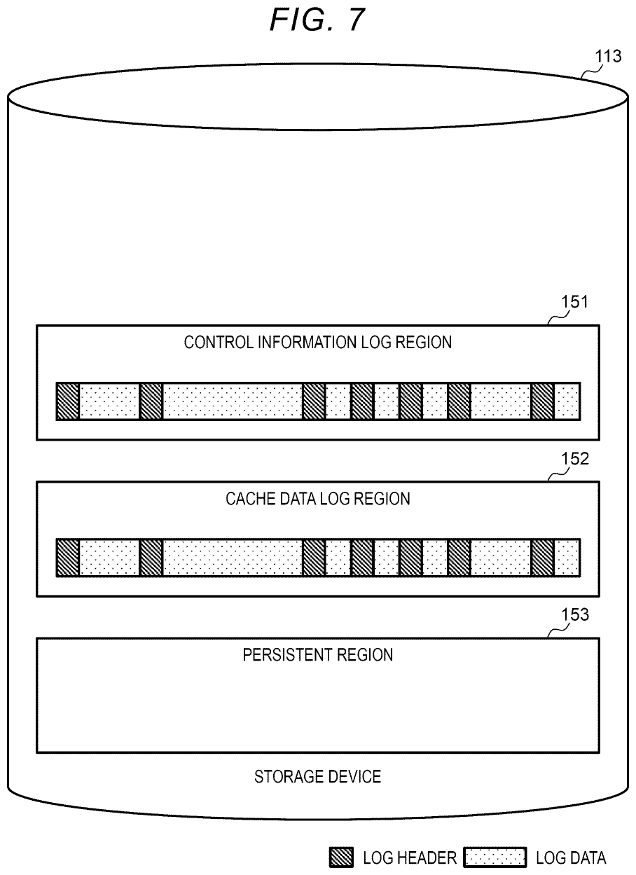

FIG. 7 shows a configuration example of the storage device 113. As shown in FIG. 7, the storage device 113 includes the control information log region 151, the cache data log region 152, and a persistent region 153.

The control information log region 151 and the cache data log region 152 are log regions that serve as evacuation destinations when the update log is evacuated to the storage device 113 by log evacuation processing to be described later. The update log temporarily stored in the control information log buffer 144 is written in the control information log region 151, and the update log temporarily updated in the cache data log buffer 145 is written in the cache data log region 152. Details of such log evacuation processing will be described later.

The persistent region 153 is a region for storing predetermined data to be persistently retained in the storage system 100, and stores user data and the like managed by the data protection control unit 125. Specifically, for example, when a data redundancy function is provided by destaging processing to be described later, compressed user data and the like are made redundant and stored in the persistent region 153.

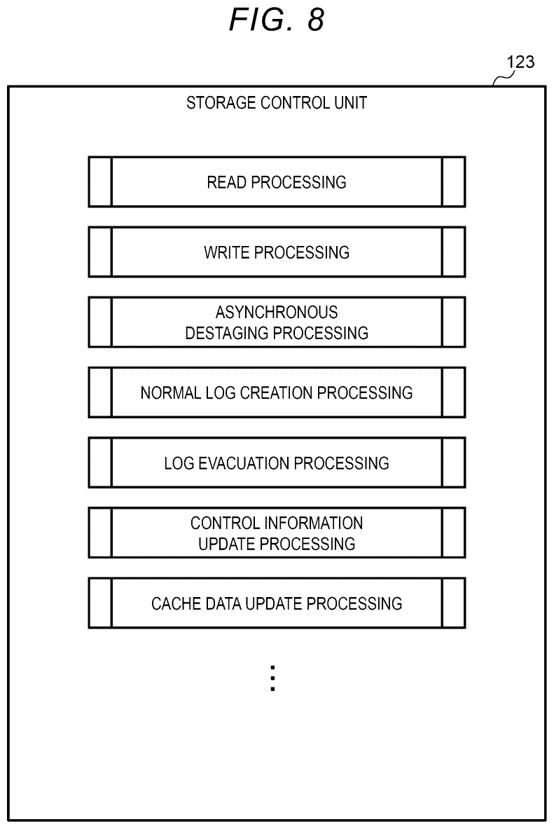

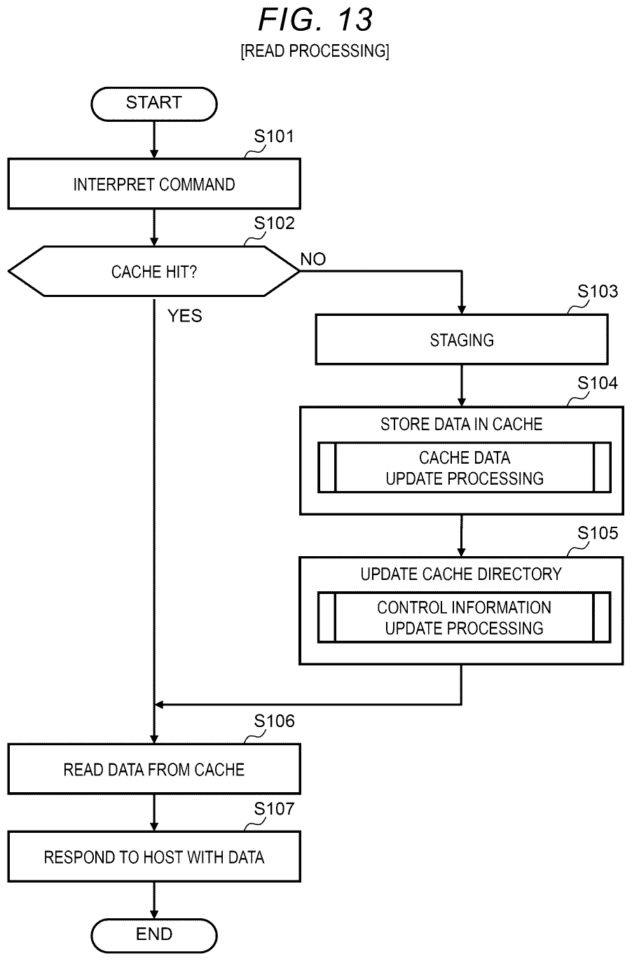

FIG. 8 shows an example of a software module structure in the storage control unit 123. FIG. 8 shows read processing, write processing, asynchronous destaging processing, normal log creation processing, log evacuation processing, control information update processing, and cache data update processing as examples of software processing executable under control of the storage control unit 123, and the storage control unit 123 (CPU 111) may also control other processing that is not shown. Processing that can be controlled and executed by the storage control unit 123 will be described later with reference to flowcharts in FIG. 13 and subsequent figures.

### (1-2) Data Configuration

FIG. 9 shows a configuration example of the cache directory 142. The cache directory 142 is the management information of the region obtained by subdividing the cache area (cache segment), and holds the entry corresponding to each cache segment.

In the case in FIG. 9, each entry corresponding to the cache segment includes fields of a segment number 1421, a logical volume number 1422, a logical volume address 1423, an attribute 1424, a data presence bitmap 1425, a dirty bitmap 1426, and an exclusive word 1427.

The segment number 1421 indicates a number of the corresponding cache segment. The logical volume number 1422 and the logical volume address 1423 indicate which address in which logical volume data stored in the cache segment belongs to. When no data is stored in the cache segment, “-” indicating no value is stored in a value of each field other than the segment number 1421.

The attribute 1424 indicates an attribute indicating whether the data stored in the cache segment is already destaged. Specifically, when the data is not yet destaged (that is, is not written to the storage device 113), a value of “Dirty” is stored in the attribute 1424, and when the data is already destaged (that is, matches a value of data already written to the storage device 113), a value of “Clean” is stored in the attribute 1424.

The data presence bitmap 1425 indicates information for managing where data is present in the cache segment. For example, when a size of the cache segment is 64 KB and a length of I/O received by the storage node 103 (storage control unit 123) from the host apparatus 101 is 8 KB, data may be partially written to the cache segment (hereinafter, also simply referred to as a segment). In such a case, using the data presence bitmap 1425, it is possible to manage where the data is present in the cache segment. Specifically, for example, the data presence bitmap 1425 can be represented by a sequence using 0 or 1, in which a value of a bit corresponding to a position where data is present in the segment is “1” and a value of a bit corresponding to a position where data is absent is “0”. A unit of each bit may be, for example, 512 B that is a minimum write unit in SCSI, which is an example of an 10 protocol from the host apparatus 101.

The dirty bitmap 1426 indicates information for managing which data in the cache segment is dirty. Similarly to the data presence bitmap 1425, the dirty bitmap 1426 may indicate a value in units of bits of a predetermined size in the cache segment (segment), and specifically, for example, the dirty bitmap 1426 can be represented by a sequence using 0 or 1, in which a value of a bit corresponding to a position where dirty data is present in the segment is “1” and a value of a bit corresponding to a position where clean data is present is “0”.

The exclusive word 1427 indicates information for managing whether exclusive control is applied to the data in the cache segment by any processor (CPU 111) in the storage system 100. In the storage system 100, when the information (data) in the cache segment is updated, it is necessary to apply the exclusive control to the data with respect to processing on another processor operating in parallel, and the exclusive word 1427 is used to enable such processing. A specific value of the exclusive word 1427 is, for example, “0 (0000 in FIG. 9)” when no processor (CPU 111) is exclusive to the data in the cache segment, and is “a value other than 0 (non-zero value)” when any processor (CPU 111) is exclusive. Here, the “non-zero value” may be determined according to any rule, and for example, when the exclusive word 1427 is represented by a four-digit number, it is conceivable that “1” is set at a first digit when any processor applies the exclusive control, and information that can specify the processor applying the exclusive control is contained in remaining three digits (second to fourth digits) (for example, “1002” means that the exclusive control is applied by the processor (CPU 111) of the storage node 103 of #2). In a case where the exclusive control is applied to the data with respect to the processing on the other processor operating in parallel when updating the information in the cache segment, an operation of “updating the value to the non-zero value when the value is 0” is performed using, for example, a compare and swap (CAS) instruction to guarantee that only one processor updates the exclusive word 1427 in the segment to the non-zero value, and it is possible to guarantee that only one processor exclusively executes one or more updates of the segment by such processing.

FIG. 10 shows a configuration example of the log header 133. As described above with reference to FIG. 5, the log header 133 is the header portion in the normal log 132 in the update log 140 stored in the log buffer region (the control information log buffer 144 and the cache data log buffer 145) on the memory 112, and is for example, data in a table format. A portion corresponding to the header in the normal log 132 in the update log 140 stored in the log region (the control information log region 151 and the cache data log region 152) on the storage device 113 may also be considered to have the same data configuration as the log header 133 shown in FIG. 10.

The log header 133 shown in FIG. 10 includes fields of a log type 1331, a log sequence number 1332, an update address 1333, an update size 1334, a region type 1335, and a valid flag 1336.

The log type 1331 holds, as a value, information (for example, a string or a number) for identifying a type of a target log. In this example, the log type of the log created along with the update of the normal control information or the cache data (normal log 132) is “normal log”, and the log type of the log created along with the update of the cache directory (consolidated log 137) is “consolidated log”. The log sequence number 1332 holds, as a value, a sequence number uniquely assigned to the target log.

The update address 1333 holds, as a value, a storage destination address of update data corresponding to the target log. Specifically, the update data corresponding to the target log (normal log 132) of the log header 133 is the normal control information or the cache data. The update size 1334 holds, as a value, a data size of the update data corresponding to the target log. For example, in the case of the normal log 132 shown in FIG. 5, since the data size of the data 131 that is the update data is 32 B, the value of the update size 1334 is “32”.

The region type 1335 holds, as a value, information for identifying whether the update data corresponding to the target log is the control information or the cache data. In this example, a string of “control information” or “cache data” is used as the value of the region type 1335, and alternatively, another identifier or the like prepared in advance may be used.

The valid flag 1336 holds, as a value, information for identifying validity of the target log (that is, whether the target log is currently valid as a log). As an example, the valid flag 1336 holds a string “valid” as a value when the target log is valid, and holds a string “invalid” as a value when the target log is invalid. As a situation where the target log is invalid, for example, a case where data of the same address is updated and a new log is created is assumed.

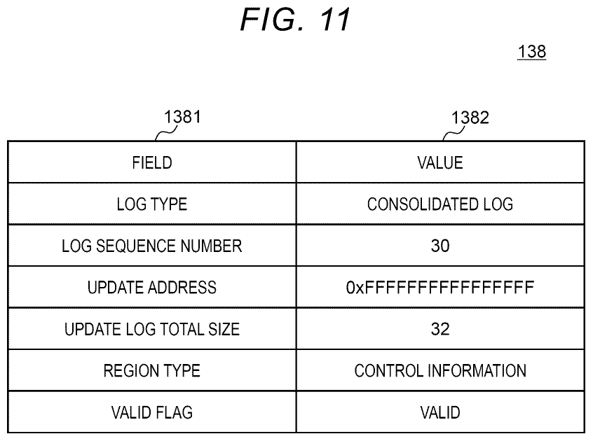

FIG. 11 shows a configuration example of the consolidated log header 138. As described above with reference to FIG. 5, the consolidated log header 138 is the header portion in the consolidated log 137 in the update log 140 stored in the control information log buffer 144 on the memory 112, and is, for example, data in a table format. A portion corresponding to the header in the consolidated log 137 in the update log 140 stored in the control information log region 151 on the storage device 113 may also be considered to have the same data configuration as the consolidated log header 138 shown in FIG. 11.

The consolidated log header 138 shown in FIG. 11 includes fields of a log type 1381, a log sequence number 1382, an update address 1383, an update log total size 1384, a region type 1385, and a valid flag 1386. The fields in the consolidated log header 138 have common parts with the fields in the log header 133 shown in FIG. 10, and differences will be mainly described below.

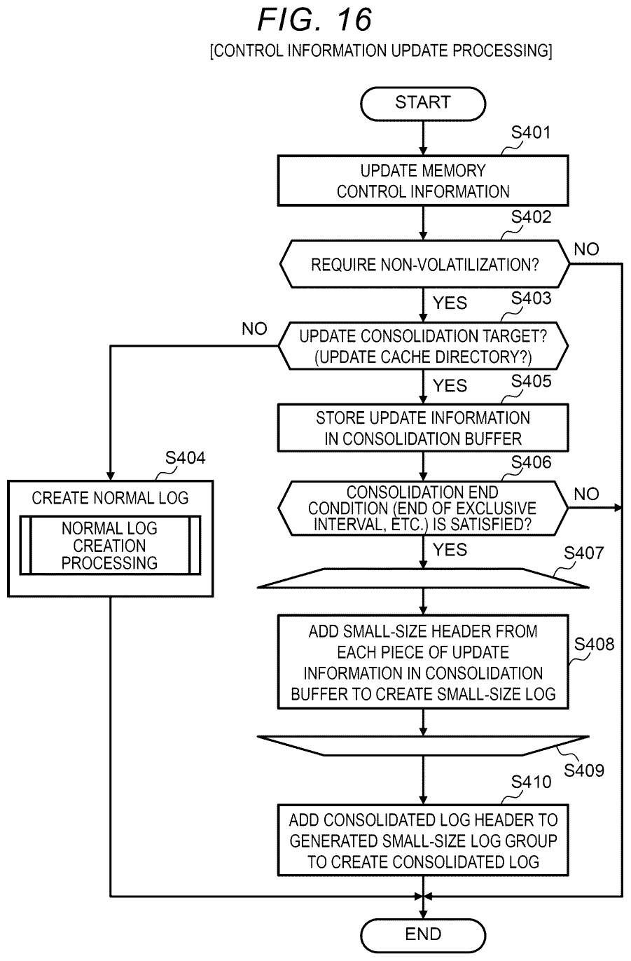

The log type 1381 holds, as a value, information for identifying a type of a target log. The log type 1331 in the log header 133 is “normal log” whereas the log type 1381 holds a string “consolidated log” as a value. Similarly to the log sequence number 1332 in the log header 133, the log sequence number 1382 holds, as a value, a sequence number uniquely assigned to the target log. Since the consolidated log 137 forms a single update log by consolidating a plurality of logs of data 134 (small-size logs 135) into the data unit while guaranteeing a data update order (write order) without controlling based on differences in log sequence numbers assigned according to a log creation order, it is sufficient that one log sequence number 1332 is assigned to one consolidated log 137. That is, order control information (log sequence number 1332) of the plurality of small-size logs 135 in one consolidated log 137 can be regarded as the same. Details on how the data update order (write order) is guaranteed when creating the consolidated log 137 will be described in a description of a “consolidation end condition” in control information processing with reference to FIG. 16.

The update address 1383 indicates information on a storage destination address of update data corresponding to the target log, similarly to the update address 1333 in the log header 133. However, since the consolidated log 137, which is the target log of the consolidated log header 138, is an update log that manages a plurality of pieces of update data (a plurality of pieces of small-size data 134) of the cache directory in a consolidated manner, the update address 1383 does not hold a storage destination address of specific update data and stores “0xFFFFFFFFFFFFFFFF” indicating an invalid value.

The update log total size 1384 holds, as a value, a total data size of the data unit (that is, the consolidated log data unit 139) in the consolidated log 137 as a data size of the update data corresponding to the target log. Since a data size of the header portion (log header 136) of each of the plurality of small-size logs 135 constituting the consolidated log data unit 139 is a fixed length, as a modification, a total data size of the small-size logs 135 may be used as the value of the update log total size 1384.

Similarly to the region type 1335 in the log header 133, the region type 1385 indicates information for identifying whether the update data corresponding to the target log is the control information or the cache data. Since the consolidated log header 138 treats the cache directory belonging to the control information as the update data, the region type 1385 holds “control information” as a value.

Similarly to the valid flag 1336 in the log header 133, the valid flag 1386 indicates information for identifying validity of the target log, and specifically, for example, holds a string of “valid” or “invalid” as a value.

FIG. 12 shows a configuration example of the log header 136 in the small-size log 135. As described above with reference to FIG. 5, the small-size log 135 is a small-size log corresponding to one piece of update data (data 134) in the cache directory, and includes the log header 136 as a header portion thereof.

Here, as described in FIG. 5, a data length (for example, 6 B) of the log header 136 in the small-size log 135 is smaller than a data length (for example, 32 B) of the log header 133 in the normal log 132. In the embodiment, by making the data size of the log header 136 in the small-size log 135 small in this way, it is possible to reduce the data size of the small-size log 135 (and further the consolidated log 137). Therefore, the field configuration of the log header 136 in the small-size log 135 is preferably simpler than the field configuration of the log header 133 in the normal log 132.

Specifically, the log header 136 shown in FIG. 12 includes fields of an update offset 1361 and an update size 1362, and can be implemented without the fields of the log type 1331, the log sequence number 1332, the region type 1335, and the valid flag 1336 in the log header 133 shown in FIG. 10. Although not shown, the log header 136 may further include a field indicating information corresponding to a 6-bit “flag” in the small-size log 135 in FIG. 5, in addition to the fields shown in FIG. 12.

The update offset 1361 is a field indicating a storage destination of the update data (data 134) corresponding to the target log (small-size log 135) by an offset value from a predetermined address. The control information related to the cache directory is a part of the entire control information and is within a smaller space than an entire memory space. Therefore, in the log header 136, the data length can be reduced by storing an offset value from a starting address (corresponding to the predetermined address described above) of a cache directory space as the update offset 1361, instead of holding an address as a value as in the update address 1333. Actually, the value of the update address 1333 in FIG. 10 is “0x0000001000000000”, whereas the value of the update offset 1361 in FIG. 12 is “0x00001000”, and thus the data length can be reduced.

The update size 1362 holds, as a value, the data size of the update data (data 134) corresponding to the target log (small-size log 135). Here, the update size 1362 may also be a data size smaller than the update size 1334 in the log header 133 in the normal log 132. For example, while the update size 1334 in the log header 133 requires 32 bits, the update size 1362 in the log header 136 can be implemented by 16 bits. This is because the cache directory information is control information different from general storage control information (normal control information), and a typical value of the update size per update is a small size of about 4 B. For example, 1 KB or the like is set as an upper limit value of the update size per update in the cache directory information.

As described above, the log header 136 that is the header portion of the small-size log 135 can reduce various fields as compared to the log header 133 in the normal log 132, and the size of the entire log header 136 can be greatly reduced as compared to the log header 133 by reducing a size of each field. Further, even in the consolidated log 137 implemented by consolidating a plurality of small-size logs 135, the entire data size can be smaller than the data size of the normal log 132.

### (1-3) Various Types of Processing

Hereinafter, various types of processing executed in the storage system 100 will be described in detail using the configuration and the data described above as necessary. The various types of processing to be described later may be considered to be executed by the CPU 111 in the storage node 103 unless otherwise specified. In the following description, the phrase “call XX processing” may be used, which means that a predetermined software module (program) for executing “XX processing” is called and executed by the processor (CPU 111).

FIG. 13 is a flowchart of a processing procedure example of the read processing. The read processing is called when the storage node 103 receives a read I/O command (read command) from the host apparatus 101, and is mainly executed by the storage control unit 123 (more strictly, the active storage control unit).

According to FIG. 13, first, the storage control unit 123 receives the read command transmitted from the host apparatus 101 via the front-end driver 121 and interprets the read command to obtain a logical volume number and a logical volume address of a read target (step S101).

Next, the storage control unit 123 determines whether read target data is a cache hit (step S102). Specifically, the storage control unit 123 refers to the cache directory 142 in a node thereof and searches for an entry corresponding to the logical volume and the logical volume address acquired in step S101 in the cache directory 142 (see FIG. 9). The storage control unit 123 determines a cache hit when there is a corresponding entry in the cache directory 142, and determines a cache miss when there is no corresponding entry.

When it is determined in step S102 that the cache hit occurs (YES in step S102), the processing proceeds to step S106. On the other hand, when it is determined in step S102 that the cache miss occurs (NO in step S102), the processing proceeds to step S206 after processing of steps S103 to S105.

In step S103, the storage control unit 123 calls staging processing. The staging processing is processing executed by the data protection control unit 125 to read, from the persistent region 153 on the storage device 113, data corresponding to the logical volume number and the logical volume address of the read target.

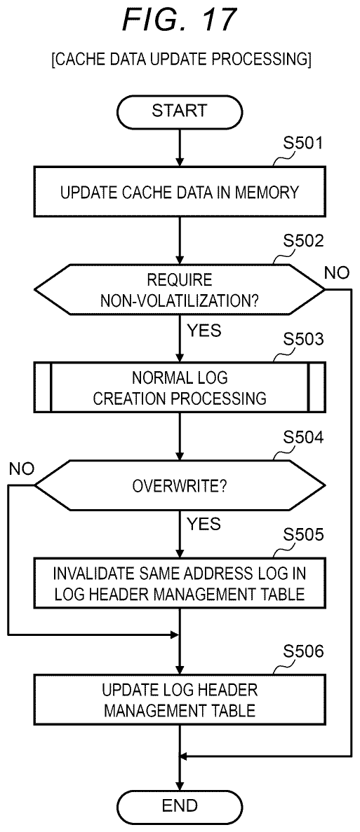

The storage control unit 123 (or the data protection control unit 125) stores the data read from the persistent region 153 in step S103 in the cache data region 143 on the memory 112 (step S104). The data storage in step S104 is executed by the storage control unit 123 setting non-volatilization requirement to “no” and calling the cache data update processing. Details of the cache data update processing will be described later with reference to FIG. 17.

Next, the storage control unit 123 performs a data update of the cache directory 142 (step S105). The data update in step S105 is executed by the storage control unit 123 calling the control information update processing. Details of the control information update processing will be described later with reference to FIG. 16. As in the case of calling the cache data update processing in step S104, the storage control unit 123 may set the non-volatilization requirement to “no” and call the control information update processing in step S105. When the processing of step S105 ends, the processing proceeds to step S106.

In step S106, the storage control unit 123 reads the read target data from the cache data region 143. Specifically, when the processing proceeds from YES in step S102 to step S106, the storage control unit 123 can read the read target data from the cache data region 143 by referring to a cache address from the entry where the cache hit occurs in step S102. When the processing proceeds to step S106 from NO in step S102 through steps S103 to S105, the storage control unit 123 can read the read target data from the cache data region 143 by referring to a storage destination address of the data in step S104.

The storage control unit 123 responds to the host apparatus 101 with the data read in step S106 (step S107), and the read processing is completed.

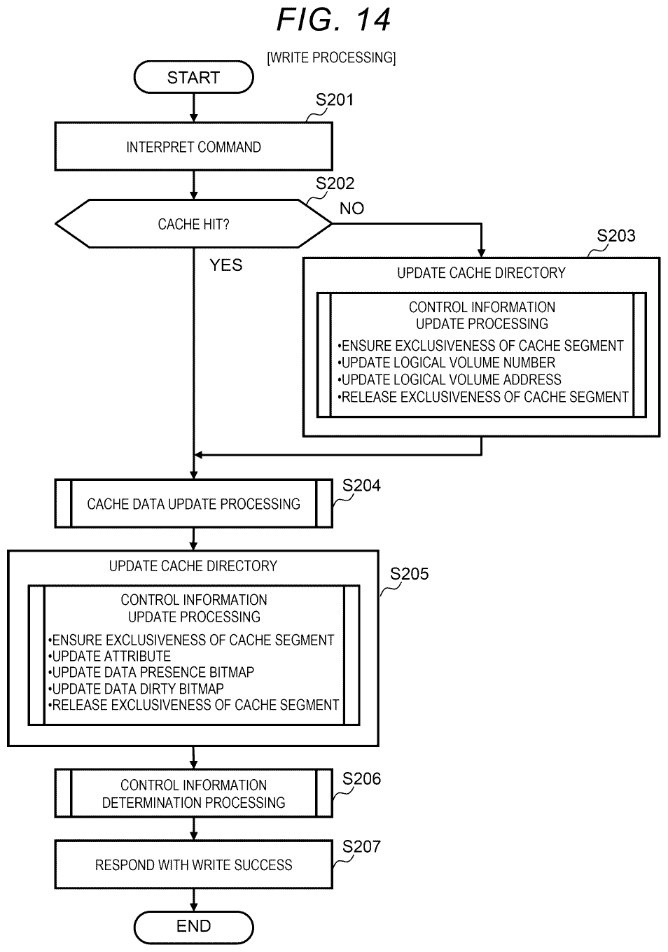

FIG. 14 is a flowchart showing a processing procedure example of the write processing. The write processing is called when a write I/O command (write command) is received from the host apparatus 101, and is mainly executed by the storage control unit 123 (more strictly, the active storage control unit).

According to FIG. 14, first, the storage control unit 123 receives the write command transmitted from the host apparatus 101 via the front-end driver 121 and interprets the write command to obtain a logical volume number and a logical volume address of a write target (step S201).

Next, the storage control unit 123 determines whether write target data is a cache hit (step S202). Specifically, the storage control unit 123 refers to the cache directory 142 in the node thereof and searches for an entry corresponding to the logical volume and the logical volume address acquired in step S201 in the cache directory 142. The storage control unit 123 determines a cache hit when there is a corresponding entry in the cache directory 142, and determines a cache miss when there is no corresponding entry.

When it is determined in step S202 that the cache hit occurs (YES in step S202), a cache address is referred to from the entry where the cache hit occurs, and the processing proceeds to step S204. On the other hand, when it is determined in step S202 that the cache miss occurs (NO in step S202), the processing proceeds to step S204 through processing of step S203.

In step S203, the storage control unit 123 newly reserves a cache segment for caching write data and updates the cache directory 142. Since the cache directory is one piece of control information, the processing of step S203 is executed by the storage control unit 123 setting the non-volatilization requirement to “yes” and calling the control information update processing a plurality of times.

More specifically, by calling the control information update processing in step S203 a plurality of times, the storage control unit 123 newly reserves the cache segment for caching the write data, updates the exclusive word 1427 to the non-zero value (to ensure an exclusive state of the cache segment) in the entry (see FIG. 9) of the cache directory managing the cache segment, updates the value of the logical volume number 1422 in the write data to be stored, updates the value of the logical volume address 1423 in the write data to be stored, and then updates the exclusive word 1427 to zero (to release the exclusive state of the cache segment). After completion of each piece of the above-described processing, the storage control unit 123 refers to a cache address of the cache segment that caches the write data, and the processing proceeds to step S204.

In step S204, the storage control unit 123 stores the write data into a predetermined cache address (that is, the cache address where the cache hit occurs in step S202 or the cache address of the cache segment reserved in step S203 without the cache hit in step S202) in the cache (cache data region 143) (to update the cache data). The processing of step S204 is executed by the storage control unit 123 setting the non-volatilization requirement to “yes” and calling the cache data update processing.

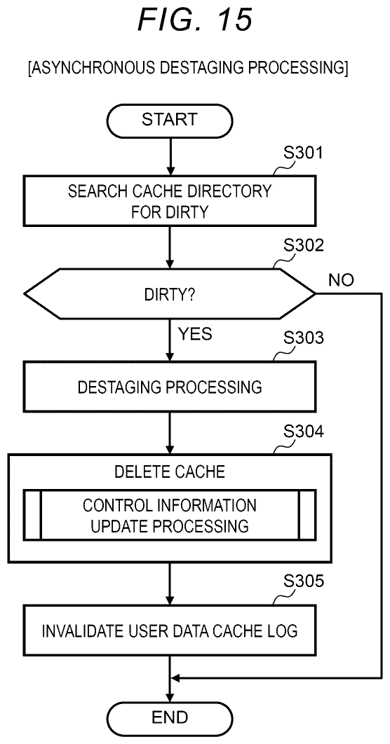

Next, the storage control unit 123 updates the cache directory 142 according to the update of the cache data in step S204 (step S205). The processing of step S205 is executed by the storage control unit 123 setting the non-volatilization requirement to “yes” and calling the control information update processing. Since a plurality of cache segments may be updated in the cache data region 143 in the update of the cache data, there may be a plurality of entries corresponding to the update in the cache directory 142. Therefore, the update of the cache data in step S205 is executed by calling the control information update processing a plurality of times for each corresponding entry. The control information update processing may be called a plurality of times when the cache directory 142 is updated not only in step S205 but also in step S105 in FIG. 13 and step S203 in FIG. 14 described above, and step S304 in FIG. 15 to be described later.

More specifically, the processing of step S205 is to update values related to presence or absence of data and dirty or not in the entry in the cache directory 142 that is a processing target by calling the control information update processing a plurality of times, and as a processing procedure, in each entry that is the processing target, the value of the exclusive word 1427 is updated to “non-zero value”, the value of the attribute 1424 is updated to “dirty”, a bit corresponding to a position where data is written in the segment is updated to “1” in the data presence bitmap 1425, a bit corresponding to a position where data is written in the segment is updated to “1” in the dirty bitmap 1426, and the value of the exclusive word 1427 is updated to “zero”.

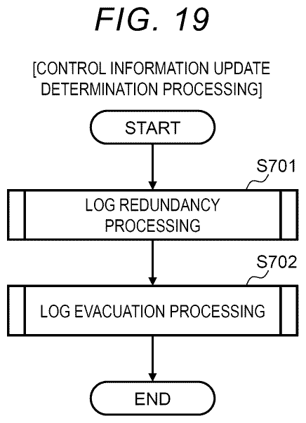

Next, the storage control unit 123 performs log redundancy processing and the log evacuation processing by calling control information determination processing (step S206). Details of the control information determination processing will be described later with reference to FIG. 19. Finally, the storage control unit 123 returns a response of write success to the host apparatus 101 (step S207) and ends the write processing.

FIG. 15 is a flowchart showing a processing procedure example of the asynchronous destaging processing. The asynchronous destaging processing is processing of destaging the data stored in the memory 112 asynchronously with update log non-volatilization processing, and is executed by the storage control unit 123 and the data protection control unit 125.

According to FIG. 15, first, the storage control unit 123 searches the cache directory 142 for an entry whose attribute 1424 is “dirty” (step S301).

Next, the storage control unit 123 determines whether there is any entry whose attribute 1424 is “dirty” (step S302), and when there is a dirty entry (YES in step S302), the processing proceeds to step S303. On the other hand, when there is no dirty entry (NO in step S302), the asynchronous destaging processing is ended.

In step S303, the storage control unit 123 cooperates with the data protection control unit 125 to execute the destaging processing targeted on a cache segment corresponding to the entry whose attribute 1424 is “dirty” (hereinafter, referred to as the entry) (step S303). Specifically, in the destaging processing of step S303, the storage control unit 123 and the data protection control unit 125 write data specified based on values of the logical volume number 1422 and the logical volume address 1423 in the entry to the persistent region 153 on the storage device 113.

In the destaging processing according to the embodiment, various known storage functions (for example, a thin provisioning function, a snapshot function, and a data redundancy function) are provided. The thin provisioning function is a function of dynamically allocating capacity in a certain size according to writing, in which a logical-to-physical conversion address that associates a logical space with a physical space is generated. In the snapshot function, data at a certain point in time is virtually stored (this is referred to as a snapshot image) and when the data is updated, only an updated region is stored in another region, and a logical-to-physical conversion address from a logical space in the snapshot image to a physical space in the other region is generated for referencing the snapshot image. In the data redundancy function, in order to make data redundant using a technique such as mirroring or erasure coding (EC), the data is protected by creating a copy of the data and storing the copy in another node or creating a redundant code (parity) from the data and storing the parity in another node. The thin provisioning function and the snapshot function are provided by the storage control unit 123, and the data redundancy function is provided by the data protection control unit 125.

After executing the destaging processing of step S303, the storage control unit 123 deletes the entry from the cache directory 142 (step S304). Since the processing of step S304 is processing of updating the cache directory 142, the processing is executed by the storage control unit 123 setting the non-volatilization requirement to “yes” and calling the control information update processing.

Finally, the storage control unit 123 invalidates a user data cache log (step S305) and ends the asynchronous destaging processing. The processing of step S305 is processing of searching a log header management table (log header 133 in FIG. 10) of a cache data update log of the user data and invalidating a user data cache log, in which the same address range (the update address 1333 and the update size 1334) as that of the data destaged by the destaging processing of step S303 is specified, by setting the value of the valid flag 1336 thereof to “invalid”.

FIG. 16 is a flowchart showing a processing procedure example of the control information update processing. The control information update processing is processing called when the control information on the memory 112 is updated. When the control information update processing is called, information indicating the non-volatilization requirement (specifically, “yes” or “no” of the non-volatilization requirement) is passed in addition to a memory address, a data size, and an update value for specifying update target control information. The processing procedure example shown in FIG. 16 is a processing procedure example of the control information update processing executed by one call. As described in the read processing of FIG. 13, the write processing of FIG. 14, and the like, the control information update processing may be continuously called a plurality of times, and in such a case, the processing shown in FIG. 16 is continuously executed in the control information update processing of each time.

According to FIG. 16, first, the storage control unit 123 updates the control information stored in the memory 112 based on the memory address, the data size, and the update value passed at the time of calling (step S401).

Next, the storage control unit 123 determines whether the non-volatilization is required based on the non-volatilization requirement information passed at the time of calling (step S402). Only when the non-volatilization is “yes” in step S402 (YES in step S402), the processing proceeds to step S403 and subsequent processing, and when the non-volatilization is “no” in step S402 (NO in step S402), the current control information update processing is ended.

In step S403, the storage control unit 123 determines whether an update log of the update target control information is a target of a consolidated log (in other words, whether the update of the control information is an update along with consolidation processing of the update log). As described above with reference to FIG. 5 and the like, in the embodiment, since the consolidated log 137 is created by combining a plurality of small-size logs 135 at the time of updating the cache directory 142, it may be determined in step S403 whether the update target control information is a cache directory. As a more specific determination method, it may be determined whether the update target control information is the cache directory based on an address of the update target control information, or a parameter indicating whether the update log is the consolidation target may be specified when the control information update processing is called from higher-level processing.

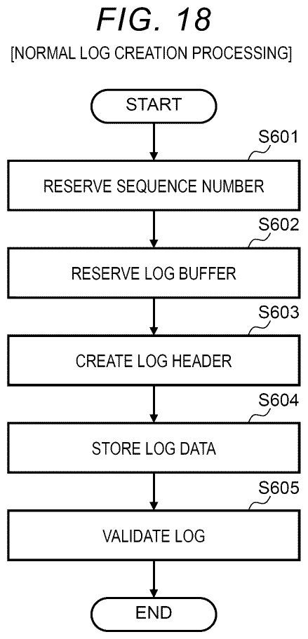

When it is determined in step S403 that the update log is not the target of the consolidated log (NO in step S403), this means that the update target control information is “normal control information” in the embodiment. In this case, the storage control unit 123 calls the normal log creation processing and creates the update log corresponding to the update of the control information in step S401 (step S404). By executing the normal log creation processing, a log header for the normal control information (corresponding to the log header 133 in FIG. 5) is created, and the update target control information is combined as a data unit (corresponding to the data 131 in FIG. 5) to create the update log corresponding to the normal control information (corresponding to the normal log 132 in FIG. 5), and a detailed processing procedure will be described later with reference to FIG. 18. After step S404 is completed, the current control information update processing is ended.

On the other hand, when it is determined in step S403 that the update log is the target of the consolidated log (YES in step S403), the storage control unit 123 stores the update target control information in a predetermined buffer for consolidation processing (hereinafter, referred to as a consolidation buffer) (step S405). The consolidation buffer is reserved in a region different from a region for storing the normal log 132 or the consolidated log 137 in the memory 112, and may be within the control information log buffer 144 or a storage region different from the control information log buffer 144.

Next, the storage control unit 123 determines whether a consolidation processing end condition (consolidation end condition) is satisfied (step S406). The consolidation end condition means a condition for ending a period in which an update order (write order) of data can be guaranteed without relying on control based on differences in log sequence numbers (that is, a period in which a plurality of pieces of small-size data 134 can be consolidated into one consolidated log 137 while guaranteeing the write order), and specifically, for example, is a timing when “the exclusive state of the cache segment” reserved when updating the cache directory is released. A reason why “the timing when the exclusive state is released” is appropriate as the consolidation end condition is that, when certain control information (cache directory) is updated, until the timing when the exclusive state of the corresponding cache segment is released (while the exclusive state is set), another processor operating in parallel with the own processor (CPU 111) does not refer to or update the control information (conversely, in an update of the control information occurring after the exclusive state is released, since there is a case where consistency of the control information on a shared memory is ensured by strictly guaranteeing an update order thereof, the update order of the data is not guaranteed unless log creation is performed at the time of the update and a sequence number is assigned). Other examples of the consolidation end condition include that the consolidation buffer is full, and that a log header generated for the control information stored in the consolidation buffer reaches an upper limit (for example, 32 B in the case of FIG. 5) of a total size that can be held in the consolidated log header 138.

The “consolidation end condition” in the description means a condition for ending a “consolidation condition” under which execution of processing of steps S407 to S410 to be described later is allowed. Specifically, for example, when the consolidation end condition is “the timing when the exclusive state of the cache segment is released”, the consolidation condition is “a state in which exclusiveness of the cache segment is set”. When the consolidation end condition is not satisfied in step S406, it can be considered that “the consolidation condition is satisfied”, and thus the execution of the processing of steps S407 to S410 is allowed. On the other hand, when the consolidation end condition is satisfied in step S406, it can be considered that “the consolidation condition is not satisfied”, and thus the execution of the processing of steps S407 to S410 is not allowed.

When the consolidation end condition is not satisfied in step S406 (NO in step S406), the storage control unit 123 ends the current control information update processing without creating any log (the small-size log 135 and the consolidated log 137).

On the other hand, when the consolidation end condition is satisfied in step S406 (YES in step S406), the storage control unit 123 repeatedly executes processing of creating, for each piece of update data (control information) stored in the consolidation buffer, the small-size log (the small-size log 135 shown in FIG. 5) by adding the small-size log header (the log header 136 shown in FIG. 5, see FIG. 12 for the configuration example thereof) to the update data (steps S407 to S409). By executing loop processing of steps S407 to S409, a plurality of small-size logs 135 are created as many as the number of pieces of small-size update data (cache directory data 134) stored in the consolidation buffer.

After the loop processing of steps S407 to S409 ends, the storage control unit 123 treats the plurality of small-size logs 135 created in the loop processing as the data unit (the consolidated log data unit 139 shown in FIG. 5) and adds the consolidated log header 138 (see FIG. 11 for the configuration of the log header) to create one consolidated log 137 (step S410). At this time, in the consolidated log 137 to which the same log sequence number is assigned, the plurality of small-size logs 135 are consolidated in the consolidated log data unit 139 in a write order thereof (in other words, an update order of the update data (data 134)). The consolidated log 137 created in step S410 is retained in the control information log buffer 144 on the memory 112. After step S410 ends, the control information update processing ends.

FIG. 17 is a flowchart showing a processing procedure example of the cache data update processing. The cache data update processing is processing called when updating the cache data on the memory 112. As described with reference to FIG. 5 and the like, in the embodiment, the update log along with the update of the cache directory in the control information is created in a special configuration including the plurality of small-size logs 135 (consolidated log 137), whereas the update log along with the update of the normal control information and the update log along with the update of the cache data are created in a common configuration (normal log 132).

Therefore, the cache data update processing shown in FIG. 17 is common to the control information update processing shown in FIG. 16 except that an update target is the cache data instead of the control information. Specifically, processing of updating the cache data on the memory 112 (step S501) and processing of determining the non-volatilization requirement (step S502) are the same as the processing of steps S401 and S402 in FIG. 16 except for the difference in the update target. Further, similarly to the case of NO in step S402 in FIG. 16, the processing is ended when it is determined in step S502 that the non-volatilization is not required (NO in step S502).

When it is determined in step S502 that the non-volatilization is required (YES in step S502), the storage control unit 123 creates the update log corresponding to the update of the cache data in step S501 (step S503). Since the processing of step S503 is executed by calling the normal log creation processing as in step S404 in FIG. 16, a detailed description thereof will be omitted.

As a difference from the control information update processing in the cache data update processing, when it is determined that the non-volatilization is required, the processing of steps S504 to S506 is performed as follows after the processing of step S503.

First, in step S504, the storage control unit 123 determines whether the update of the cache data in step S501 is an overwrite. Specifically, the storage control unit 123 refers to the log header management table (the log header 133 shown in FIG. 10) of a cache data log stored in the cache data log buffer 145, searches for a log having the same address (update address 1333) as the cache data updated in step S501, and when there is such a log, the storage control unit 123 can determine that the update is an overwrite. In the case of the overwrite (YES in step S504), the storage control unit 123 invalidates a log of overwritten original data by setting the value of the valid flag 1336 to “invalid” for the corresponding log header management table (log header 133) in the cache data log buffer 145 (step S505). Finally, the storage control unit 123 adds a log header of the log created in the normal log creation processing of step S503 to the log header management table in the cache data log buffer 145 (step S506) and ends the cache data update processing.

FIG. 18 is a flowchart showing a processing procedure example of the normal log creation processing. The normal log creation processing is processing called when a log (an update log, more specifically, the normal log 132 shown in FIG. 5) along with the update of the normal control information or the cache data is created. As described with reference to FIGS. 5 and 6, the normal log 132 (which may be replaced with the update log 140) created when the normal control information is updated is temporarily stored in the control information log buffer 144 in the memory 112, the normal log 132 (which may be replaced with the update log 140) created when the cache data is updated is temporarily stored in the cache data log buffer 145 in the memory 112, and a temporary storage destination of the normal log 132 in the memory 112 is simply referred to as the “log buffer” in the following description.

According to FIG. 18, first, the storage control unit 123 determines a sequence number (log sequence number) of the log to be created (step S601). The log sequence number is order control information assigned in an order of log creation, and one log corresponds one-to-one to one log sequence number.

Next, the storage control unit 123 reserves a region for writing the log in the log buffer (step S602). The normal log creation processing shown in FIG. 18 may be executed by a plurality of processes operating in parallel, and in this case, it is necessary to perform exclusive processing such that the same log sequence number is not acquired by another process and the same log buffer region is not reserved by another process.

Next, the storage control unit 123 creates the log header 133 (step S603). The configuration example of the log header 133 is as described in FIG. 10, and specifically, the value of “normal log” is stored in the log type 1331, the log sequence number determined in step S601 is stored in the log sequence number 1332, and values of an update target address and an update size on the memory 112 passed when the current normal log creation processing is called are stored in the fields of the update address 1333 and the update size 1334. The field of the region type 1335 stores the value of “control information” when the control information is updated, and stores the value of “cache data” when the cache data is updated.

Next, the storage control unit 123 stores the log (normal log 132) in the log buffer (step S604). This log includes the log header 133 created in step S603, and the control information or the cache data that is the update data. On the log buffer, the log header 133 is stored at the start of the region reserved in step S602, and the update data is stored at a memory address obtained by adding a size of the log header 133 to a starting address of the region.

Finally, the storage control unit 123 validates the log by setting the value of the valid flag 1336 in the log header 133 stored in the log buffer in step S604 to “valid” (step S605), and ends the normal log creation processing.

FIG. 19 is a flowchart showing a processing procedure example of control information update determination processing. The control information update determination processing is processing called at a final stage when updating the control information.

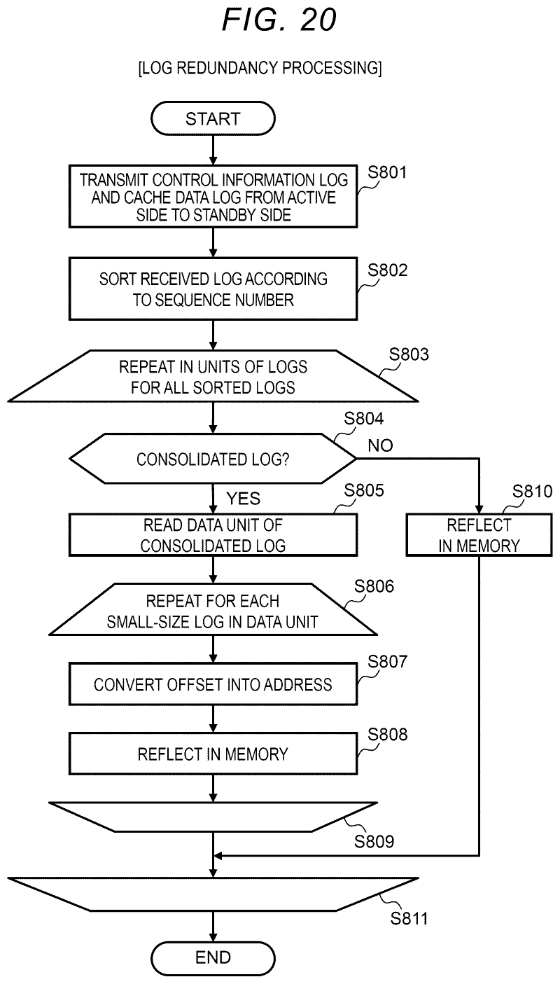

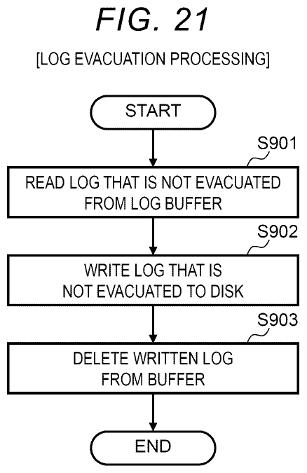

As shown in FIG. 19, in the control information update determination processing, the storage control unit 123 first calls the log redundancy processing (step S701) and then calls the log evacuation processing (step S792). The log redundancy processing is processing of making a log including update data (update log) redundant, and details thereof will be described later with reference to FIG. 20. The log evacuation processing is processing of writing the log (update log) that is not evacuated on the memory 112 to the storage device 113, and details thereof will be described later with reference to FIG. 21.

FIG. 20 is a flowchart showing a processing procedure example of the log redundancy processing.

According to FIG. 20, first, the active-side storage control unit 123 (active storage control unit) transmits, via an inter-node network, a log stored in the control information log buffer 144 (control information log) and a log stored in the cache data log buffer 145 (cache data log) to the standby-side storage control unit 123 (standby storage control unit) in the storage control unit group 124 to which the active-side storage control unit 123 belongs (step S801).

Next, the standby storage control unit sorts logs received in step S801 in an order from an oldest log (in other words, a log having a smallest log sequence number) to a newest log (in other words, a log having a largest log sequence number) according to the respective log sequence numbers (step S802). When the control information log is the consolidated log 137 created along with the update of the cache directory, the consolidated log 137 is treated as one log. Therefore, when the control information log is the consolidated log 137, in the processing of step S802, the consolidated log header 138 is treated as a header portion that can be referred to, and individual small-size logs 135 constituting the data unit (consolidated log data unit 139) of the consolidated log 137 are not individually referred to.

The standby storage control unit repeats reflection processing of reflecting update data added to the logs on the memory 112 in units of logs in the order from the oldest log to the newest log (or in a reverse order) among the logs sorted in step S802 (steps S803 to S811), and ends the log redundancy processing.

A detailed processing procedure of the reflection processing will be described. First, the standby storage control unit determines whether a processing target log is a consolidated log (step S804).

When the processing target log is the normal log in step S804 (NO in step S804), the standby storage control unit copies, according to information on an address and a size contained in the log header in the normal log (the log header 133 in the normal log 132 shown in FIG. 5), the data unit (the data 131 in the normal log 132 shown in FIG. 5) of the normal log to the address of the memory 112 by the size and thus reflects the copy in the memory 112 (step S810). After the processing in step S810, the current loop processing in the reflection processing is ended, and the processing proceeds to next loop processing.

On the other hand, when the processing target log is the consolidated log in step S804 (YES in step S804), the standby storage control unit reads the data unit of the consolidated log (the consolidated log data unit 139 in the consolidated log 137 shown in FIG. 5) (step S805). In steps S806 to S809, the standby storage control unit repeats the following processing for each small-size log (the small-size log 135 shown in FIG. 5) in the data unit read in step S805. Specifically, first, the offset value (the value of the update offset 1361 shown in FIG. 12) in the small-size log is read and converted into an address (step S807). As a conversion method, for example, the offset value is added to the starting address of the cache directory region. Next, the standby storage control unit copies the small-size log to the address converted in step S807 to reflect the copy on the memory 112 (step S808). After the loop processing of steps S806 to S809 is ended, the current loop processing in the reflection processing is ended, and the processing proceeds to next loop processing.

As described above, by executing the processing of steps S801 to S811, each data unit of the control information log and the cache data log temporarily stored on the active-side memory 112 is reflected on the standby-side memory 112 to implement redundancy.

FIG. 21 is a flowchart showing a processing procedure example of the log evacuation processing.

According to FIG. 21, first, the storage control unit 123 (active storage control unit) refers to the log buffer (the control information log buffer 144 and the cache data log buffer 145) to read a log that is not evacuated (step S901). Next, the storage control unit 123 stores the log that is not evacuated and read in step S901 in the log region (the control information log region 151 and the cache data log region 152) on the storage device 113 (step S902). A write position in step S902 may be, for example, a position immediately after a last written log. When the writing in step S902 is completed, the storage control unit 123 deletes the log from the log buffer (the control information log buffer 144 and the cache data log buffer 145) on the memory 112 (step S903) and ends the log evacuation processing.

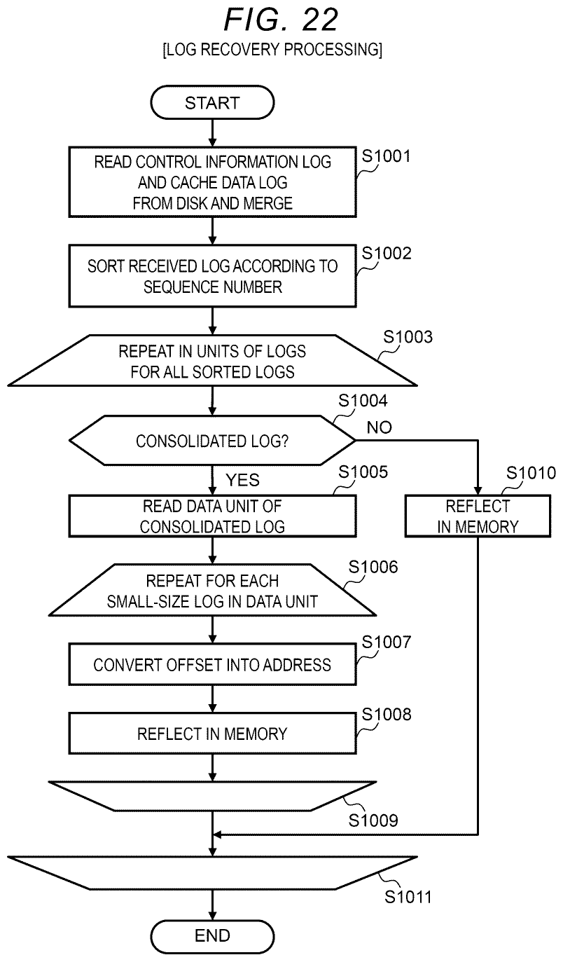

FIG. 22 is a flowchart showing a processing procedure example of log recovery processing. The log recovery processing is called before the storage control unit 123 is activated and is executed by the storage controller (for example, the data protection control unit 125) upon restart after a power failure occurring after the update log non-volatilization processing is executed and before the destaging processing is executed.

According to FIG. 22, the storage controller first reads the control information log and the cache data log from all log regions on the storage device 113, merges the read logs, and transmits the same to the memory 112 (step S1001). Next, the storage controller sorts the logs received in step S1001 in an order from an oldest log (in other words, a log having a smallest log sequence number) to a newest log (in other words, a log having a largest log sequence number) according to the respective log sequence numbers (step S1002).

Thereafter, similarly to the processing of steps S803 to S811 in the log redundancy processing shown in FIG. 20, the storage controller performs, for all the logs sorted in step S1002, processing according to a type of each log in units of logs to reflect the logs on the memory 112 (steps S1003 to S1011), and ends the log recovery processing.

As described above, by executing the processing of steps S1001 to S1011, the control information log and the cache data log stored on the storage device 113 in a non-volatile manner can be placed at the same address on the memory 112 (for example, the control information log buffer 144 or the cache data log buffer 145) as that before the power failure at the time of restart after recovery from the power failure. After the log recovery processing is ended, the recovery from the power failure is completed by executing the destaging processing (for example, the asynchronous destaging processing shown in FIG. 15) that is not executed due to the power failure.

Here, as described above, the processing of making the consolidated log redundant (steps S806 to S809 of the log redundancy processing shown in FIG. 20) and the processing of recovering the consolidated log (steps S1006 to 1009 of the log recovery processing shown in FIG. 22) are performed in units of small-size logs (the small-size logs 135 shown in FIG. 5) in the consolidated log. At this time, in the log header 136 in the small-size log 135, by holding only the offset value from the starting address of the cache directory information region on the memory 112 instead of an address value, a size of information indicating a log reflection position can be reduced, and the size of the log header 136 including the information can be reduced. As a result, it is possible to obtain an effect of relatively reducing the size of the entire consolidated log 137 in which a plurality of cache directory logs are consolidated, as compared to a case where a log corresponding to each individual cache directory is created.

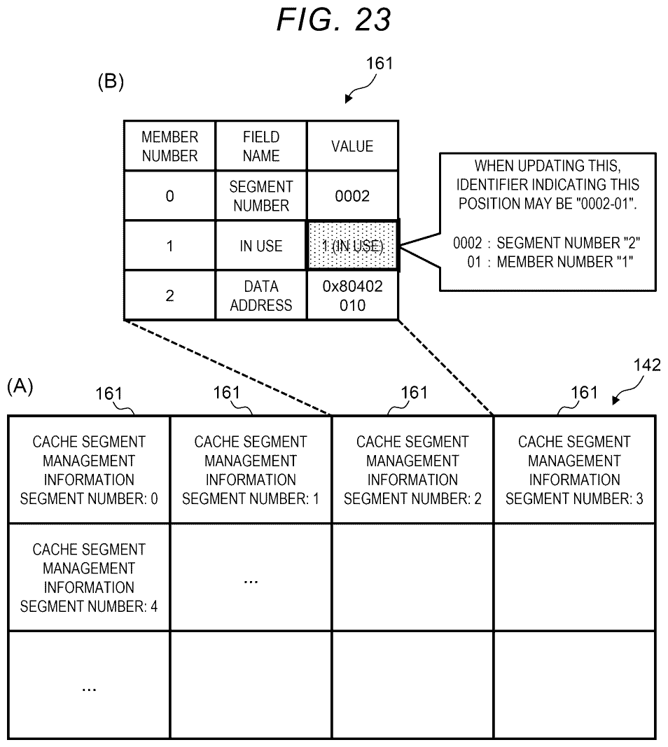

In this way, in the embodiment, the size of the information indicating the log reflection position can be reduced by using the offset value in the log header 136 in the plurality of small-size logs 135 in the consolidated log 137, and the following method may be adopted as a modification. This will be described in detail with reference to FIG. 23.

FIG. 23 shows the modification in which the size of the information indicating the log reflection position is reduced.

As shown in (A) in FIG. 23, as a part of the control information, it is conceivable that the cache directory 142 holds, for each cache segment (segment) obtained by dividing the cache data region into a certain size, an array of segment management information (cache segment management information 161) for managing each segment.

When a part of such cache segment management information 161 is updated at the time of updating the cache directory 142, as a method for indicating an address of data that is an update target (hereinafter, referred to as an update target member) instead of using the offset value from the starting address of the entire control information in the cache directory 142 as described above, in the modification, a combination of identification information of the cache segment management information 161 including the update target member (a value of a segment number shown in (A) in FIG. 23) and identification information of the update target member in the cache segment management information 161 (a value of a member number shown in (B) in FIG. 23) may be used.

Specifically, for example, in a case where an item indicated by shading in (B) in FIG. 23 is the update target member, since the item is an item indicating a value of an “in use” field to which a member number of “1” is assigned in the cache segment management information 161 whose segment number is “2”, the item can be represented by information such as “0002-01” by combining the segment number “2” and the member number “1”. When such a modification is adopted, an amount of information can be further reduced as compared to a case where the address of the update target member is represented by “the starting address of the cache directory 142+the offset value”. Thus, it is possible to reduce the size of the information indicating the log reflection position in the update log (consolidated log 137) of the control information created along with the update of the cache directory 142.

As described above, in the storage system 100 according to the embodiment, when the cache directory 142 is updated, the plurality of small-size logs 135 corresponding to the plurality of pieces of small-size data 134 updated in the cache directory 142 are consolidated and created as one consolidated log 137, and thus a log data amount can be reduced. Specifically, at the time of updating the control information such as the cache directory 142 having a relatively small update size and a relatively large number of updates, a plurality of updates are consolidated to create one log (consolidated log 137), and at this time, the small-size log header 136 is added to each update of the control information, thereby allowing a data amount of the consolidated log (consolidated log 137) to be reduced. Since the log data amount can be reduced as described above, it is possible to prevent an increase in overhead of the processor (CPU 111) in the storage system 100, a communication amount of the network 102, a load on the storage device 113, and the like. Thus, the storage system 100 according to the embodiment can have both high performance and high reliability even when the control information is updated.

### (2) Second Embodiment

In a second embodiment, a configuration example will be described in which a data compression function is added to the storage system 100 described in the first embodiment.

The compression function added in the second embodiment is an example of the storage function provided by the storage control unit 123, and by compressing and storing data received by the storage node 103 from the host apparatus 101 using a data compression algorithm such as LZ4, the function can reduce capacity consumption, save capacity of the disk (storage device 113), and reduce disk cost. When the compression function is used, a processing time is increased by a time for compression processing, but since data can be processed at a reduced size after compression, the processing time can be expected to be shortened when viewed as a whole.

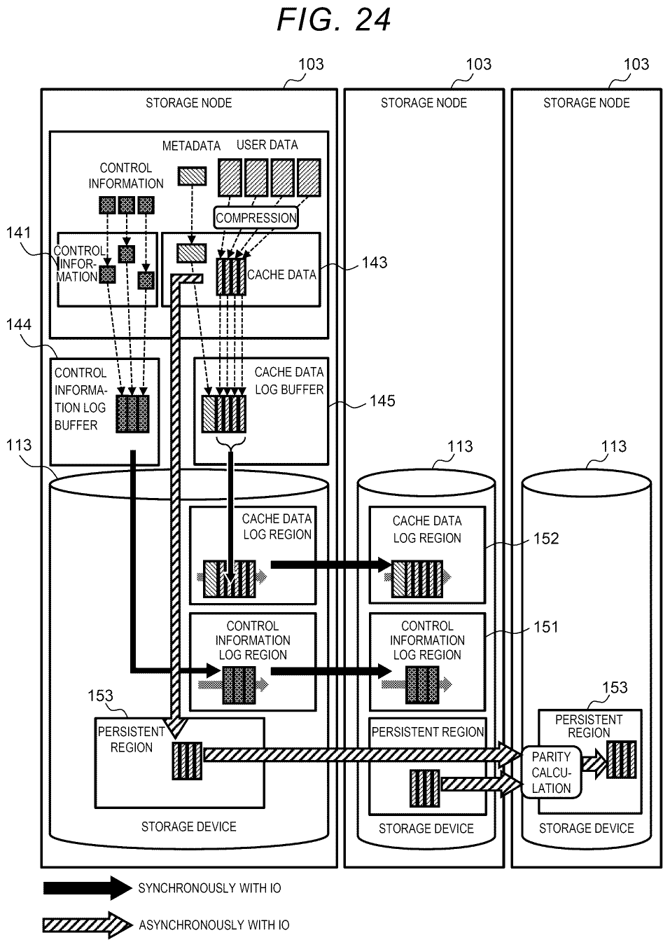

FIG. 24 shows a data processing image of the compression function. As shown in FIG. 24, data (for example, user data) received by the storage node 103 from the host apparatus 101 is stored in the cache data region 143. Processing at this time is substantially the same as the write processing shown in FIG. 14, and is different in that data to be written to the memory 112 is compressed, and that the compressed data and metadata indicating a position thereof are written.

In the compression function according to the embodiment, the compressed data and the metadata are written in the cache data region 143 in an append writing manner. As a reason therefor, since a size after compression of the data received from the host apparatus 101 is indefinite depending on a compression effect, a case is assumed where the size of the compressed data is larger than that of the old data and replacement is not available even when attempting to overwrite the old data with the compressed data. Therefore, in the compression function according to the embodiment, it can be said that the append writing manner is appropriate in which a new region is always reserved in the cache data region 143, the compressed data is written as cache data, and a region where the old data is stored is released as a free region after writing. In addition, since the append writing manner is used, the information (metadata) indicating the storage position of the compressed data is necessary, and the metadata is also stored in the cache data region 143.

The compressed data and the metadata stored in the cache data region 143 are stored in the cache data log region 152 on the storage device 113 synchronously with host 10 (that is, before a response is returned from the storage node 103 to the host apparatus 101).

When storing the cache data or the control information stored in the memory 112 into the log region in the storage device 113, the storage system 100 may adopt an operation of writing a plurality of logs accumulated in the log buffer in the memory 112 in a consolidated manner in a single disk write (so-called “batch writing”), and by performing such batch writing, processing efficiency can be improved, the number of disk writes in the storage device 113 can be reduced, and performance of the storage system 100 can be improved. Since the control information is smaller in size than the data such as the user data compressed and stored in the cache data region 143, the control information may be stored in the control information region 141 without being compressed as shown in FIG. 24.

Here, in order to consolidate a large number of logs in the batch writing, it is conceivable to perform the log evacuation processing (see FIG. 21) after waiting for more logs to accumulate in the log buffer, and in this case, a response of the control information determination processing (see FIG. 19) executed before an I/O response is delayed, which leads to delay in a response to host I/O. In order to prevent such a situation, in the storage system 100 according to the embodiment, all logs accumulated in the log buffer may be batch-written when the log evacuation processing is called, and the start of the log evacuation processing may not be delayed. In this way, when an I/O load on storage is high and a large number of logs are accumulated in the log buffer at the same time (when the load is high), efficiency of storing data in the storage device 113 is naturally increased by the batch writing, and when the I/O load on the storage is low (when the load is low), the data can be written in the storage device 113 without delaying the response to the host I/O more than necessary. Thus, the storage system 100 according to the embodiment can have both high throughput performance required when the load is high and reduction in response delay required when the load is low.

The compressed data and the metadata stored in the cache data region 143 are written out to the persistent region 153 on the disk (storage device 113) asynchronously with the host I/O. Such processing is the asynchronous destaging processing shown in FIG. 15. In the asynchronous destaging processing, the compressed data and the metadata are written in an append writing manner as in the writing to the cache data region 143. In the asynchronous destaging, it is possible to improve processing efficiency by batch-writing proximate data in a single disk write, and it is possible to reduce the number of disk writes and improve the performance. In particular, with respect to the compressed data adopting the append writing manner, the batch writing is easily performed, and this point is the same as when storing in the cache data log region described above. The destaging requires more processing than the log evacuation processing.

In the second embodiment, as in the first embodiment, logs are consolidated when the control information is updated. Data to be consolidated is information in the cache directory 142 as in the first embodiment. Since the metadata is frequently updated particularly when the compression function is used, the information in the cache directory 142 is frequently updated when the metadata is written on the cache data region 143, updated, and referred to. In such a case, the storage system 100 according to the embodiment effectively consolidates logs in particular.

In the storage system 100 according to the second embodiment, the same processing as the log consolidation at the time of log creation in the first embodiment can be applied to a cache data log of the metadata created along with the update in the cache data region 143 (particularly, metadata updates that occur a plurality of times per I/O). Specifically, the storage control unit 123 performs storage in the consolidation buffer and consolidated log creation from each piece of update data in the consolidation buffer even at the time of log creation along with the update of the metadata stored in the cache data region 143, similarly to the processing when creating the update log (consolidated log 137) of the cache directory 142 in step S107 in the read processing in FIG. 13 in the first embodiment. By performing such processing, for the metadata shown in FIG. 24, it is possible to expect reduction in overhead due to the log consolidation, similarly to the log consolidation of the log in the cache directory in the first embodiment.

Similarly to the description with reference to FIG. 15 in the first embodiment, in the second embodiment, in the destaging processing (step S303 in FIG. 15) executed by the data protection control unit 125 in the asynchronous destaging processing, data can be made redundant using a technique such as mirroring or erasure coding (EC).

FIG. 24 shows the data redundancy processing image when EC is used, and parity data calculated with other data is stored in another node (the storage node 103 different from the original storage node 103), thereby making the data redundant.

As described above, in the second embodiment, by batch-writing the logs of the control information and the cache data (or at least a part of these logs) in a predetermined log region, it is possible to improve the processing efficiency and to improve storage performance by reducing the number of disk writes. Also in the destaging processing, an effect of the batch-writing is improved particularly when the compression function is used, the improvement in the processing efficiency and the reduction in the number of disk writes can be expected, and thus the improvement in the storage performance can be expected.

Since data flowing through the disk (storage device 113) is also reduced by the compression function as compared to an uncompressed case, the disk can be efficiently used, and the effect of improving the performance is also obtained.

As described above, the storage system 100 includes the storage control unit 123 as the storage controller that controls reading and writing from and to the storage device 113 that is non-volatile storage, and the storage controller generates a log and stores the log in the memory 112 that is a log memory and writes the log stored in the memory 112 to the storage device 113 at the time of reading and writing. The generated log includes the control information log and the cache data log. When the control information log is generated, the control information log is stored in the log memory (control information log buffer 144), and is batch-written to the storage device 113 (the control information log region 151 and the persistent region 153) in units of storage regions having a plurality of control information logs. When the cache data log is generated, the cache data log is stored in the log memory (cache data log buffer 145), and the cache data in the log memory is compressed and written to the storage device 113 (the cache data log region 152 and the persistent region 153). With such configurations and operations, the storage system 100 can implement a storage system having both high performance and high reliability.

The above-described storage system 100 includes a plurality of storage controllers (storage control units 123), and has a configuration in which the storage controllers are made redundant between different storage nodes 103. With such a configuration, in the storage system 100, the control information, the cache data, and the like can be efficiently stored in the storage device 113 in each storage node 103, and thus high performance and high reliability can be obtained.

The invention is not limited to the above-described embodiments, and includes various modifications. For example, the above-described embodiments have been described in detail to facilitate understanding of the invention, and the invention is not necessarily limited to those including all the configurations described above. In addition to deletion of such a configuration, it is also possible to replace or add a configuration.

Specifically, for example, in the first embodiment, an example has been described in which the sequence number is used as the order control information assigned according to the log creation order in order to control the data update order (the log sequence number 1332 in FIG. 10 and the log sequence number 1382 in FIG. 11), and as a modification, a time stamp may be assigned to the log and the time stamp may be used as the order control information of the log. As another modification, a pointer to a next log may be added to a certain log and used as the order control information of the log. Instead of the configuration in which the order control information is assigned in units of logs, a configuration in which the order control information is assigned in units of logs in a certain range may be adopted.

What is claimed is:

1. A storage system comprising:
one or more storage nodes each including a volatile memory, a non-volatile storage device, and a storage controller that processes data read from or written to at least the memory or the storage device, wherein
the memory stores cache data and control information for accessing data on the storage device,
as the data is written in response to a write request, the control information corresponding to the data is updated, and the control information includes first-type control information and second-type control information having an update size smaller than that of the first-type control information,
the storage controller is configured to execute
log creation processing of, when the write request is processed and the control information or the cache data is updated, adding a header to updated data to create an update log and storing the created update log in a log buffer in the memory,
update log non-volatilization processing of storing, in the storage device, the update log stored in the log buffer by the log creation processing, and responding to a requestor of the write request, and
destaging processing of destaging, to the storage device, the update log stored in the log buffer in the memory,
in the log creation processing when the first-type control information is updated, the storage controller adds a log header to each piece of the updated first-type control information to create an update log, and stores the update log in the log buffer, and
in the log creation processing when the second-type control information is updated, the storage controller creates one consolidated log as an update log related to a plurality of pieces of the second-type control information, and stores the consolidated log in the log buffer.

2. The storage system according to claim 1, wherein
order control information indicating a creation order of the update log is added to the update log, and
in the log creation processing, the storage controller creates the consolidated log by consolidating a plurality of update logs related to the plurality of pieces of the second-type control information based on the order control information of the second-type control information, and adds the order control information to the consolidated log.

3. The storage system according to claim 2, wherein
in the log creation processing, for a plurality of pieces of the second-type control information satisfying a predetermined consolidation condition, the storage controller adds, to each piece of the updated second-type control information, a small-size log header having a more limited amount of information than the log header added to the update log related to the first-type control information to create a small-size log, combines the plurality of created small-size logs into one data unit, and adds a log header to the one data unit to create the one consolidated log.

4. The storage system according to claim 2, wherein
the memory includes, separately from the log buffer, a consolidated log creation buffer that temporarily stores the plurality of pieces of the second-type control information for each of which the small-size log is created.

5. The storage system according to claim 1, wherein
the storage controller is configured to execute the destaging processing asynchronously with the update log non-volatilization processing.

6. The storage system according to claim 1, wherein
upon restart after a power failure occurring at the storage node after the update log non-volatilization processing is executed and before the destaging processing is executed, the storage controller reads the update log stored in the storage device, reflects the update log in the memory, and then enables execution of the destaging processing.

7. The storage system according to claim 1, further comprising:
a plurality of the storage nodes each including a plurality of the storage controllers, wherein
one or more storage controller groups are formed by combining a first storage controller set to an active mode for receiving an I/O request from a host apparatus and a second storage controller set to a standby mode in which the I/O request from the host apparatus is not received, across two or more storage nodes among the plurality of storage nodes, and
in the same storage controller group, the first storage controller transmits the update log stored in the log buffer of the storage node of the first storage controller to the second storage controller, and the second storage controller reflects the update log received from the first storage controller in the memory of the storage node of the second storage controller to enable execution of log redundancy processing.

8. The storage system according to claim 1, wherein
the storage controller further has a compression function of compressing and storing data, and
the storage controller stores, in the memory, the data compressed using the compression function, and executes the log creation processing, the update log non-volatilization processing, and the destaging processing on the compressed data.

9. The storage system according to claim 1, wherein
in the memory, an update log related to an update of the control information is stored in a first log buffer, and an update log related to an update of the cache data is stored in a second log buffer different from the first log buffer in the memory, and
the storage controller batch-writes a plurality of update logs stored in each log buffer of the first and second log buffers to the storage device.

10. A storage control method performed by a storage system including one or more storage nodes, wherein
the one or more storage nodes each include a volatile memory, a non-volatile storage device, and a storage controller that processes data read from or written to at least the memory or the storage device,
the memory stores cache data and control information for accessing data on the storage device,
as the data is written in response to a write request, the control information corresponding to the data is updated, and the control information includes first-type control information and second-type control information having an update size smaller than that of the first-type control information,
the method comprises:
a log creation step of, when the write request is processed and the control information or the cache data is updated, causing the storage controller to add a header to updated data to create an update log and store the created update log in a log buffer in the memory;
an update log non-volatilization step of causing the storage controller to store, in the storage device, the update log stored in the log buffer in the log creation step, and to respond to a requestor of the write request; and
a destaging step of causing the storage controller to destage, to the storage device, the update log stored in the log buffer in the memory,
in the log creation step when the first-type control information is updated, the storage controller adds a log header to each piece of the updated first-type control information to create an update log, and stores the update log in the log buffer, and
in the log creation step when the second-type control information is updated, the storage controller creates one consolidated log as an update log related to a plurality of pieces of the second-type control information, and stores the consolidated log in the log buffer.
